(19) United States
(12) Patent Application Publication
(10) Pub. No.: US 2007/0069982 A1
(43) Pub. Date: Mar. 29, 2007

(54) Plasma display apparatus and driving method thereof

(76) Inventors: Kirack Park, Chilgok-gun (KR); Jongwoon Bae, Gumi-si (KR); Seonghwan Ryu, Gumi-si (KR); Yoonjoo Cho, Seoul (KR); Dooyong Hwang, Yongin-si (KR)

Correspondence Address: FLESHNER & KIM, LLP, P.O. BOX 221200, CHANTILLY, VA, 20153, US

(21) Appl. No.: 11/295,697

(22) Filed: Dec. 7, 2005

(30) Foreign Application Priority Data
Sep. 23, 2005 (KR) 10-2005-0089007

(51) Int. Cl. G09G 3/28

(52) U.S. Cl. 345/60

(57) ABSTRACT

The present invention relates to a plasma display apparatus and driving method thereof, in which scan electrodes Y are scanned according to one or more of a plurality of scan types. The scan electrodes Y are scanned according to any one of a plurality of scan types. Therefore, generation of an excessive displacement current can be prevented and electrical damage to data driver ICs can be prevented accordingly. The plasma display apparatus of the present invention can include a plurality of scan electrodes, a plurality of data electrodes intersecting the plurality of scan electrodes, a scan driver which scans the scan electrodes using one of a plurality of scan types whose orders where the plurality of scan electrodes are scanned in an address period are different from one another, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period, and a data driver that supplies a data pulse to the data electrodes corresponding to the one scan type.

### CROSS-REFERENCES TO RELATED APPLICATIONS

This Nonprovisional application claims priority under 35 U.S.C. § 119(a) on Patent Application No. 10-2005-0089007 filed in Korea on Sep. 23, 2005 the entire contents of which are hereby incorporated by reference.

### BACKGROUND OF THE INVENTION

1. Field of the Invention

The present invention relates to a plasma display apparatus, and more particularly, to a plasma display apparatus and driving method thereof, in which scan electrodes Y are scanned according to one or more of a plurality of scan types.

2. Background of the Related Art

In general, a plasma display panel comprises a front panel and a rear panel. Barrier ribs formed between the front panel and the rear panel form one cell. Each cell is filled with a primary discharge gas, such as neon (Ne), helium (He) or a mixed gas of Ne+He, and an inert gas containing a small amount of xenon (Xe). A plurality of these cells form one pixel. For example, a red (R) cell, a green (G) cell and a blue (B) cell form one pixel.

In the plasma display panel, if the inert gas is discharged with a high frequency voltage, it generates vacuum ultraviolet rays. Phosphors formed between the barrier ribs are excited to display images. The plasma display panel can be made thin and light, and has thus been in the spotlight as the next-generation display devices.

In the plasma display panel are formed a plurality of electrodes such as a scan electrode Y, a sustain electrode Z and a data electrode X. A predetermined driving voltage is applied to the plurality of electrodes to generate a discharge, displaying images. To apply the driving voltage to the electrodes of the plasma display panel, a driver Integrated Circuit (IC) is connected to the electrodes.

For example, a data driver IC is connected to the data electrode X of the electrodes of the plasma display panel. A scan driver IC is connected to the scan electrode Y of the electrodes of the plasma display panel.

Meanwhile, when the plasma display panel is driven, a displacement current (Id) flows through the above-described driver ICs. The displacement current has its amount changed according to various factors.

For example, the displacement current flowing through the above-described data driver IC can be increased or decreased depending on equivalent capacitance (C) of the plasma display panel and a switching number of the data driver IC. More particularly, the displacement current flowing through the data driver IC is increased as equivalent capacitance (C) of the plasma display panel is increased and also increased as a switching number of the data driver IC is increased.

Meanwhile, the equivalent capacitance (C) of the plasma display panel is decided by the equivalent capacitance (C) between the electrodes. This will be described below with reference to FIG. 1.

FIG. 1 is a view illustrating equivalent capacitance (C) of a plasma display panel.

Referring to FIG. 1, the equivalent capacitance (C) of the plasma display panel comprises equivalent capacitance (Cm1) between the data electrodes, such as a data electrode X1 and a data electrode X2, equivalent capacitance (Cm2) between the data electrode and the scan electrodes, such as the data electrode X1 and a scan electrode Y1, and equivalent capacitance (Cm2) between the data electrode and the sustain electrode such as the data electrode X1 and a sustain electrode Z1.

Meanwhile, the state of a voltage applied to the scan electrode Y or the data electrode X is changed according to the operation of a switching element included in a drive IC, such as a scan drive IC, for driving the scan electrode Y by supplying a scan pulse to the scan electrode Y in an address period, and a drive IC, such as a data driver IC, for driving the data electrode X by supplying a data pulse to the data electrode X in an address period. Therefore, the displacement current (Id) that is generated the aforementioned equivalent capacitance (Cm1) and the equivalent capacitance (Cm2) flows through the data driver IC through the data electrode.

As described above, if the equivalent capacitance of the plasma display panel is increased, the amount of the displacement current (Id) flowing through the data driver IC is increased. If the switching number of the data driver IC is increased, the amount of the displacement current (Id) is increased. The switching number of the data driver IC is varied depending on input image data.

More particularly, in the case of a specific pattern in which a logic value of image data is repeated between 0 and 1, the amount of the displacement current flowing through the data driver IC is excessively increased. Therefore, there is a problem in electrical damage such as burning of a data driver IC.

### SUMMARY OF THE INVENTION

Accordingly, an object according to the present invention is to solve at least the problems and disadvantages of the background art.

To solve the problems, an object of the present invention is to provide a plasma display apparatus and driving method thereof, in which scanning is performed according to selected one or more of a plurality of scan types, thus preventing electrical damage to driver ICs.

A plasma display apparatus of the present invention for accomplishing the above object comprises a plurality of scan electrodes, a plurality of data electrodes intersecting the plurality of scan electrodes, a scan driver which scans the scan electrodes using one of a plurality of scan types whose orders where the plurality of scan electrodes are scanned in an address period are different from one another, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period, and a data driver that supplies a data pulse to the data electrodes corresponding to the one scan type.

Furthermore, a plasma display apparatus for accomplishing the above object comprises a plasma display panel in which a plurality of scan electrodes and data electrodes intersecting the scan electrodes are formed, a scan driver that scans the scan electrodes by setting a scan order of the plurality of scan electrodes to be different from those in the case of a first data pattern in a second data pattern different from the first data pattern of data patterns of input image data, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period, and a data driver that supplies a data pulse to the data electrodes corresponding to the one scan type.

Furthermore, to accomplish the above object, a method of driving a plasma display apparatus comprising scan electrodes and data electrodes intersecting the scan electrodes are formed comprises the steps of scanning the scan electrodes using one of a plurality of scan types whose orders where the plurality of scan electrodes are scanned in an address period are different from one another, wherein an end point of the scanning of a first scan electrode, of the first scan electrode and a second scan electrode whose scan order is consecutive, of the plurality of scan electrodes, is set to be earlier than the starting point of the scanning of the second scan electrode whose scan order is later than the scanning order of the first scan electrode, when the scan electrodes are scanned in the address period, and supplying a data pulse to the data electrodes corresponding to the one scan type.

Furthermore, to accomplish the above object, a method of driving a plasma display apparatus comprising scan electrodes and data electrodes intersecting the scan electrodes are formed comprises the steps of scanning the scan electrodes by setting a scan order of the plurality of scan electrodes to be different from those in the case of a first data pattern in a second data pattern different from the first data pattern of data patterns of input image data, wherein an end point of the scanning of a first scan electrode, of the first scan electrode and a second scan electrode whose scan order is consecutive, of the plurality of scan electrodes, is set to be earlier than the starting point of the scanning of the second scan electrode whose scan order is later than the scanning order of the first scan electrode, when the scan electrodes are scanned in the address period, and supplying a data pulse to the data electrodes corresponding to the one scan type.

As described above in detail, in the plasma display apparatus and driving method thereof according to the present invention, scan electrodes Y are scanned according to any one of a plurality of scan types. It is thus possible to prevent generation of an excessive displacement current and electrical damage to data driver ICs accordingly.

Furthermore, a time lag between an end point of scanning and the starting point of the scanning between two scan electrodes whose scan order is consecutive in the address period is controlled. It is thus possible to prohibit an erroneous discharge from occurring between two scan electrodes whose scan order is consecutive.

### BRIEF DESCRIPTION OF THE DRAWINGS

The invention will be described in detail with reference to the following drawings in which like numerals refer to like elements.

FIG. 1 is a view illustrating equivalent capacitance (C) of a plasma display panel;

FIG. 2 is a view illustrating a plasma display apparatus according to the present invention;

FIGS. 3a and 3b are views illustrating an exemplary structure of a plasma display panel according to the present invention;

FIG. 4 is a view illustrating a method of implementing the gray levels of an image in a plasma display apparatus according to the present invention;

FIG. 5 is a view illustrating the amount of a displacement current depending on input image data;

FIGS. 6a and 6b are views illustrating an exemplary method of changing a scan order considering image data and a displacement current accordingly;

FIG. 7 is a view illustrating another application example in a driving method of a plasma display apparatus according to the present invention;

FIG. 8 is a view illustrating the construction and operation of a scan driver for realizing the method of driving the plasma display apparatus according to the present invention;

FIG. 9 shows a basic circuit block included in a data comparator 1000 included in the scan driver of the plasma display apparatus according to the present invention;

FIG. 10 is a view illustrating, in more detail, the operation of first to third decision units of a data comparator;

FIG. 11 is a table showing pattern contents of image data depending on output signals of first to third decision units 734-1, 734-2 and 734-3 included in the basic circuit block of the data comparator according to the present invention;

FIG. 12 is a block diagram of a data comparator 1000 and a scan order decision unit 1001 of a scan driver in the plasma display apparatus according to the present invention;

FIG. 13 is a table showing pattern contents of image data depending on output signals of first to third decision units XOR1, XOR2 and XOR3 included in the data comparator according to the present invention;

FIG. 14 is a block diagram illustrating another construction of a basic circuit block included in the data comparator 1000 included in the scan driver of the plasma display apparatus according to the present invention;

FIG. 15 is a table showing pattern contents of image data depending on output signals of first to ninth decision units XOR1 to XOR9 included in the circuit block of FIG. 14 according to the present invention;

FIG. 16 is a block diagram of the data comparator 1000 and the scan order decision unit 1001 of the scan driver in the plasma display apparatus of the present invention taking FIGS. 14 and 15 into consideration;

FIG. 17 is a block diagram of an embodiment in which a data comparator and a scan order decision unit are applied every sub-field according to the present invention;

FIG. 18 is a view illustrating an exemplary method of selecting a sub-field that scans the scan electrodes Y according to any one of a plurality of scan types within one frame;

FIG. 19 is a view illustrating that scan orders can be different from each other in patterns of two different image data;

FIG. 20 is a view illustrating an exemplary method of controlling a scanning order by setting a critical value depending on an image data pattern;

FIG. 21 is a view illustrating an exemplary method of deciding a scan order corresponding to scan electrode groups, each comprising a plurality of scan electrodes Y;

FIG. 22 is a view illustrating an example of a driving waveform depending on a driving method of a plasma display apparatus according to the present invention;

FIGS. 23a and 23b are views illustrating an exemplary method of placing a time lag between the end point and the starting point of the scanning between two scan electrodes in the method of driving the plasma display apparatus according to the present invention;

FIG. 24 is a view illustrating the relation between three or more scan electrodes in which scan order is consecutive;

FIG. 25 is a view illustrating an exemplary method of placing a time lag between the end point and the starting point of the scanning in the second scan type (Type2) of FIG. 7;

FIG. 26 is a view illustrating an example of a case where a time lag is placed between the end point and the starting point of the scanning between predetermined ones of a plurality of scan electrodes; and

FIG. 27 is a view illustrating another example of a case where a time lag is placed between an end point and the starting point of the scanning between predetermined ones of a plurality of scan electrodes.

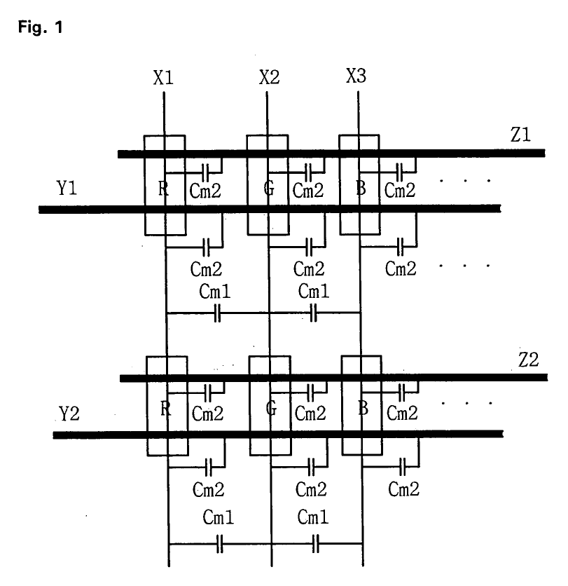

### DETAILED DESCRIPTION OF THE PREFERRED EMBODIMENT

Preferred embodiments according to the present invention will be described in a more detailed manner with reference to the drawings.

A plasma display apparatus for accomplishing the above object comprises a plurality of scan electrodes, a plurality of data electrodes intersecting the plurality of scan electrodes, a scan driver which scans the scan electrodes using one of a plurality of scan types whose orders where the plurality of scan electrodes are scanned in an address period are different from one another, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period, and a data driver that supplies a data pulse to the data electrodes corresponding to the one scan type.

In this case, the scan driver calculates a displacement current corresponding to each of the plurality of scan types corresponding to input image data, and scans the scan electrodes according to one scan type whose displacement current is the lowest, of the plurality of scan types.

Furthermore, the scan electrodes comprise the first and second scan electrodes that are separated by a predetermined number of what according to the scan type, the data electrodes comprise first and second data electrodes, the plasma display apparatus comprises first and second discharge cells disposed at the intersections of the first scan electrode and the first and second data electrodes, and third and fourth discharge cells disposed at the intersections of the second scan electrode and the first and second data electrodes, and the scan driver compares data of the first to the fourth discharge cells to calculate a displacement current for the first discharge cell.

Furthermore, the scan driver finds a first result in which the data of the first discharge cell and the data of the second discharge cell are compared, a second result in which the data of the first discharge cell and the data of the third discharge cell are compared and a third result in which the data of the third discharge cell and the data of the fourth discharge cell are compared, decides a calculation equation of the displacement current according to a combination of the first to the third results, and sums the displacement currents calculated using the decided calculation equation to calculate a total of a displacement current for the first discharge cell.

Furthermore, assuming that the capacitance between the adjacent data electrodes is Cm1, and the capacitance between the data electrodes and the scan electrodes and the capacitance between the data electrodes and sustain electrodes is Cm2, the scan driver calculates the displacement current according to a combination of the first to the third results on the basis of Cm1 and Cm2.

Furthermore, the scan driver calculates a displacement current for the plurality of scan types in each of sub-fields of one frame, and scans the scan electrodes according to a scan type in which the displacement current is the lowest for every sub-field.

Furthermore, the scan types comprise a first scan type in which scanning is performed with the scan electrodes being divided into a plurality of groups, and the scan driver consecutively scans the scan electrodes belonging to the same group in the first scan type in the case where the scan type in which the displacement current is the lowest is a first scan type.

Furthermore, the scan driver calculates a displacement current corresponding to each of the plurality of scan types corresponding to the input image data, and scans the scan electrodes according to at least one of scan types in which the displacement current is less than a predetermined critical displacement current, of the plurality of scan types.

Furthermore, the starting point of the scanning is a time point where a voltage of a scan pulse supplied to the scan electrodes is 90% or less of the highest voltage, while gradually falling from the highest voltage, when the scan electrodes are scanned.

To the contrary, the end point of scanning is a time point where a voltage of a scan pulse supplied to the scan electrodes is 90% or more of the highest voltage, while gradually rising from the lowest voltage, when the scan electrodes are scanned.

Furthermore, the plurality of scan electrodes comprises a third scan electrode whose scan order is consecutive to that of the second scan electrode and is later than that of the second scan electrode, and the scan driver sets an end point of the scanning of the second scan electrode to be earlier than the starting point of the scanning of the third scan electrodes.

Furthermore, the third scan electrode and the second scan electrode are adjacent to each other, and the second scan electrode and the first scan electrode are adjacent to each other.

Furthermore, the plurality of scan electrodes comprises a third scan electrode whose scan order is consecutive to that of the second scan electrode and is later than that of the second scan electrode, and the scan driver sets an end point of the scanning of the second scan electrode to be later than the starting point of the scanning of the third scan electrodes.

Furthermore, the third scan electrode and the second scan electrode are adjacent to each other, and one or more scan electrodes different from the first and second scan electrodes are disposed between the second scan electrode and the first scan electrode.

Furthermore, a time lag between the end point of the scanning of the first scan electrode and the starting point of the scanning of the second scan electrode is 10 ns to 1000 ns.

Furthermore, a time lag between the end point of the scanning of the first scan electrode and the starting point of the scanning of the second scan electrode is value ranging from 1/100 to 1 times of a predetermined scan pulse width.

Furthermore, to accomplish the above object, a plasma display apparatus comprises a plasma display panel in which a plurality of scan electrodes and data electrodes intersecting the scan electrodes are formed, a scan driver that scans the scan electrodes by setting a scan order of the plurality of scan electrodes to be different from those in the case of a first data pattern in a second data pattern different from the first data pattern of data patterns of input image data, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period, and a data driver that supplies a data pulse to the data electrodes corresponding to the one scan type.

Furthermore, a load value depending on a pattern of data, of any one of the first data pattern and the second data pattern has, is a predetermined critical load value or higher.

Furthermore, to accomplish the above object, a method of driving a plasma display apparatus comprising scan electrodes and data electrodes intersecting the scan electrodes are formed comprises the steps of scanning the scan electrodes using one of a plurality of scan types whose orders where the plurality of scan electrodes are scanned in an address period are different from one another, wherein an end point of the scanning of a first scan electrode, of the first scan electrode and a second scan electrode whose scan order is consecutive, of the plurality of scan electrodes, is set to be earlier than the starting point of the scanning of the second scan electrode whose scan order is later than the scanning order of the first scan electrode, when the scan electrodes are scanned in the address period, and supplying a data pulse to the data electrodes corresponding to the one scan type.

Furthermore, to accomplish the above object, a method of driving a plasma display apparatus comprising scan electrodes and data electrodes intersecting the scan electrodes are formed comprises the steps of scanning the scan electrodes by setting a scan order of the plurality of scan electrodes to be different from those in the case of a first data pattern in a second data pattern different from the first data pattern of data patterns of input image data, wherein an end point of the scanning of a first scan electrode, of the first scan electrode and a second scan electrode whose scan order is consecutive, of the plurality of scan electrodes, is set to be earlier than the starting point of the scanning of the second scan electrode whose scan order is later than the scanning order of the first scan electrode, when the scan electrodes are scanned in the address period, and supplying a data pulse to the data electrodes corresponding to the one scan type.

A plasma display apparatus and driving method thereof according to the present invention will be described in detail with reference to the accompanying drawings.

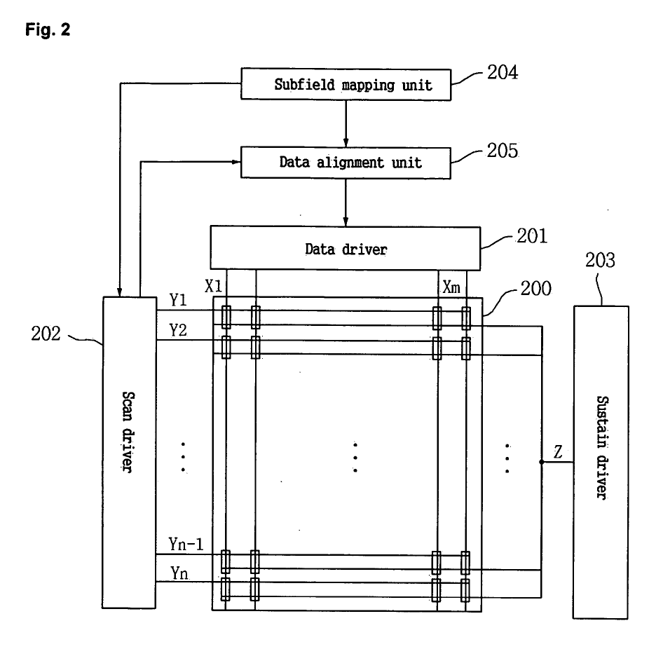

FIG. 2 is a view illustrating a plasma display apparatus according to the present invention.

Referring to FIG. 2, the plasma display apparatus of the present invention comprises a plasma display panel 200, a data driver 201, a scan driver 202, a sustain driver 203, a sub-field mapping unit 204 and a data aligner 205.

The plasma display panel 200 comprises a front panel (not shown) and a rear panel (not shown), which are combined together with a predetermined therebetween. A plurality of electrodes, such as scan electrodes Y and sustain electrodes Z parallel to the scan electrodes Y, is formed in the plasma display panel 200. Data electrodes X crossing the scan electrodes Y and the sustain electrodes Z are further formed in the plasma display panel 200.

The scan driver 202 supplies a ramp-up waveform (Ramp-up) and a ramp-down waveform (Ramp-down) to the scan electrodes Y during a reset period. The scan driver 202 also supplies a sustain pulse (SUS) to the scan electrodes Y during a sustain period. More particularly, the scan driver 202 scans the scan electrodes Y using one of a plurality of scan types in which the order of scanning the plurality of scan electrodes Y in the address period is different. In other words, the scan driver 202 supplies a scan pulse (Sp) of a negative scan voltage (−Vy) to the scan electrodes Y during the address period using one of the plurality of scan types.

Furthermore, the scan driver 202 sets an end point for the scanning of a first scan electrode, of the first scan electrode and a second scan electrode whose scan order is consecutive, of the plurality of scan electrodes Y, to be earlier than the starting point of the scanning of the second scan electrode whose scan order is later than the scanning order of the first scan electrode when the scan electrodes Y are scanned in the address period.

The sustain driver 203 supplies the sustain pulse (SUS) to the sustain electrodes Z while operating alternately with the scan driver 202 during the sustain period, and provides a predetermined bias voltage (Vzb) to the sustain electrodes Z in the address period and/or a set-down period.

The sub-field mapping unit 204 sub-field maps image data, which are externally supplied, e.g., from a halftone correction unit, and then outputs the sub-field mapped data.

The data aligner 205 re-aligns the data sub-field mapped by the sub-field mapping unit 204 so that the data correspond to each of the data electrodes X of the plasma display panel 200.

The data driver 201 samples and latches the data that are re-aligned by the above-described data aligner 205 under the control of a timing controller (not shown), and provides the data to the data electrodes X. More particularly, the data driver 201 supplies the data to the data electrodes X correspondingly to a scan type in which the scan driver 202 scans the scan electrodes Y.

The function, operation and characteristics of each of the constituent elements of the plasma display apparatus according to the present invention will become clear through description on a method of driving the plasma display apparatus according to the present invention.

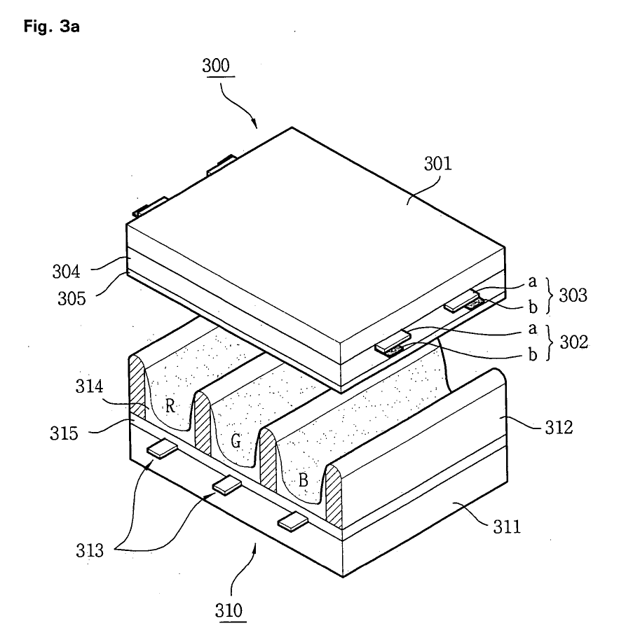

An example of the plasma display panel 200 (i.e., one of the constituent elements of the plasma display apparatus according to the present invention) will be described in more detail with reference to FIGS. 3a and 3b.

FIGS. 3a and 3b are views illustrating an exemplary structure of a plasma display panel according to the present invention.

As shown in FIG. 3a, the plasma display panel comprises a front panel 300 and a rear panel 310. In the front panel 300, a plurality of sustain electrode in which scan electrodes 302, Y and sustain electrodes 303, Z are formed in pairs is arranged on a front substrate 301 serving as a display surface on which images are displayed. In the rear panel 310, a plurality of data electrodes 313, X crossing the plurality of sustain electrodes is arranged on a rear substrate 311 serving as a rear surface. The front panel 300 and the rear panel 310 are combined parallel to each other with a predetermined distance therebetween.

The front panel 300 comprises the pairs of scan electrodes 302, Y and sustain electrodes 303, Z, which mutually discharge one another and maintain the emission of a cell within one discharge cell. In other words, each of the scan electrode 302, Y and the sustain electrode 303, Z comprises a transparent electrode (a) formed of a transparent ITO material and a bus electrode (b) formed of a metal material. The scan electrodes 302, Y and the sustain electrodes 303, Z are covered with one or more dielectric layers 304 for limiting a discharge current and providing insulation among the electrode pairs. A protection layer 305 having Magnesium Oxide (MgO) deposited thereon is formed on the dielectric layers 304 in order to facilitate discharge conditions.

In the rear panel 310, barrier ribs 312 of stripe form (or well form), for forming a plurality of discharge spaces, i.e., discharge cells are arranged parallel to one another. Furthermore, the plurality of data electrodes 313, X, which perform an address discharge to generate vacuum ultraviolet rays, are disposed parallel to the barrier ribs 312. R, G and B phosphor layers 314 that radiate a visible ray for displaying images during an address discharge are coated on a top surface of the rear panel 310. A lower dielectric layer 115 for protecting the data electrodes 313, X is formed between the data electrodes 313, X and the phosphor layers 314.

There is shown in FIG. 3a only an example of the plasma display panel structure (i.e., one of the driving elements of the plasma display apparatus according to the present invention). The present invention is, however, not limited to the structure of FIG. 3a. Furthermore, it has been shown in FIG. 3a that the scan electrodes 302 Y and the sustain electrodes 303, Z are formed in the front panel 300 and the data electrodes 313, X are formed in the rear panel 310. However, the scan electrodes 302 Y, the sustain electrodes 303 Z and the data electrodes 313 X can be all formed in the front panel 300.

It has also been shown and described that each of the scan electrodes 302, Y and the sustain electrodes 303, Z comprises the transparent electrode (a) and the bus electrode (b). However, one or more of the scan electrodes 302, Y and the sustain electrodes 303, Z can include only the bus electrode (b).

In the plasma display panel of the structure as shown in FIG. 3a, the arrangement structure of the electrodes is shown in FIG. 3b.

Referring to FIG. 3b, in the plasma display panel 300, the scan electrodes Y and the sustain electrodes Z are parallel to each other. The data electrodes X cross the scan electrodes Y and the sustain electrodes Z. Drivers are connected to the electrodes.

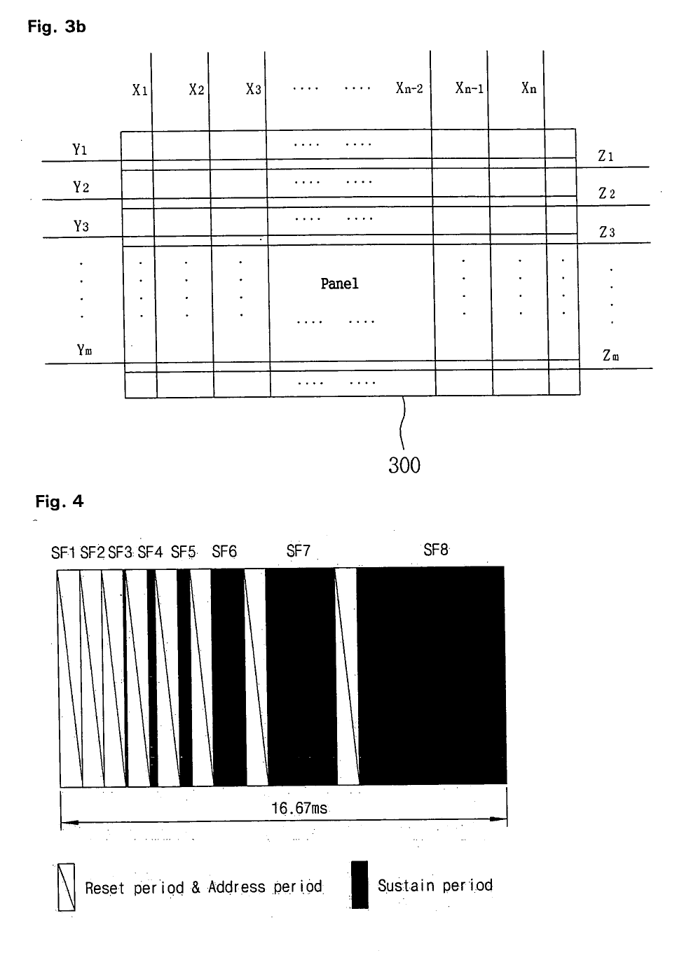

The plasma display apparatus comprising the plasma display panel according to the present invention implements gray levels of various images with a frame being divided into a plurality of sub-fields. A method of implementing gray levels in the plasma display apparatus of the present invention will be described below with reference to FIG. 4.

FIG. 4 is a view illustrating a method of implementing gray levels of an image in the plasma display apparatus according to the present invention.

Referring to FIG. 4, the method of implementing gray levels of an image in the plasma display apparatus of the present invention is performed with one frame being divided into several sub-fields having a different number of emissions. In this case, each of the sub-fields is divided into a reset period (RPD) for initializing the entire cells, an address period (APD) for selecting a discharge cell to be discharged, and a sustain period (SPD) for implementing gray levels depending on a discharge number.

For example, if it is desired to display images with 256 gray levels, a frame period (16.67 ms) corresponding to 1/60 seconds is divided into eight sub-fields (SF1 to SF8) as shown in FIG. 4. Each of the eight sub-fields (SF1 to SF8) is again divided into a reset period, an address period and a sustain period.

In this case, the reset period and the address period of each sub-field are the same every sub-field.

Furthermore, a data discharge for selecting a discharge cell to be discharged is generated by a voltage difference between the data electrodes X and the scan electrodes Y.

The sustain period is a period where a gray level weight in each sub-field is decided. For example, the gray level weight of each sub-field can be decided so that it is increased in the ratio of 2ⁿ (where n=0, 1, 2, 3, 4, 5, 6, 7) in such a manner that the gray level weight of a first sub-field is set to 2⁰ and the gray level weight of a second sub-field is set to 2¹. Gray levels of various images can be implemented by controlling the number of sustain pulses provided in a sustain period of each of sub-fields according to a gray level weight in the sustain period in each sub-field, as described above.

A case where one frame includes eight sub-fields has been described in FIG. 4. The number of sub-fields constituting one frame can be, however, changed in various manners. For example, one frame can include twelve sub-fields from a first sub-field to a twelfth sub-field. Furthermore, ten sub-fields can constitute one frame.

It has also been shown in FIG. 4 that the sub-fields are arranged in order in which the amount of gray level weights is increased in one frame. However, sub-fields can be arranged in order in which the amount of gray level weights decreases in one frame, or sub-fields can be arranged regardless of their gray level weights.

A detailed function and operation of the plasma display apparatus according to the present invention, which implements gray levels of an image using the method, will become clear through description on the method of driving the plasma display apparatus according to the present invention.

The method of driving the plasma display apparatus according to the present invention will be described in short. In the method of driving the plasma display apparatus according to the present invention, the scan electrodes Y are scanned using one of a plurality of scan types in which the order of scanning the plurality of scan electrodes Y in the address period is different. An end point of the scanning of a first scan electrode, of the first scan electrode and a second scan electrode whose scan order is consecutive, of the plurality of scan electrodes Y, is set to be earlier than the starting point of the scanning of the second scan electrode whose scan order is later than the scanning order of the first scan electrode, when the scan electrodes Y are scanned in the address period.

In the method of driving the plasma display apparatus according to the present invention, the method of scanning the scan electrodes Y using one of the plurality of scan types in which the order of scanning the plurality of scan electrodes Y in the address period is different will be first described.

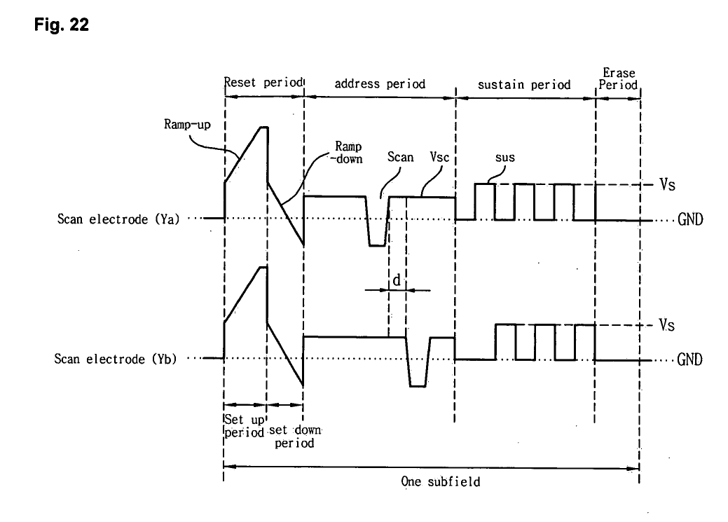

Meanwhile, as one of major characteristics of the present invention, what the end point of the scanning of the first scan electrode, of the first scan electrode and the second scan electrode whose scan order is consecutive, of the plurality of scan electrodes Y, is set to be earlier than the starting point of the scanning of the second scan electrode whose scan order is later than the scanning order of the first scan electrode when the scan electrodes Y are scanned in the address period will be described in detail beginning FIG. 22.

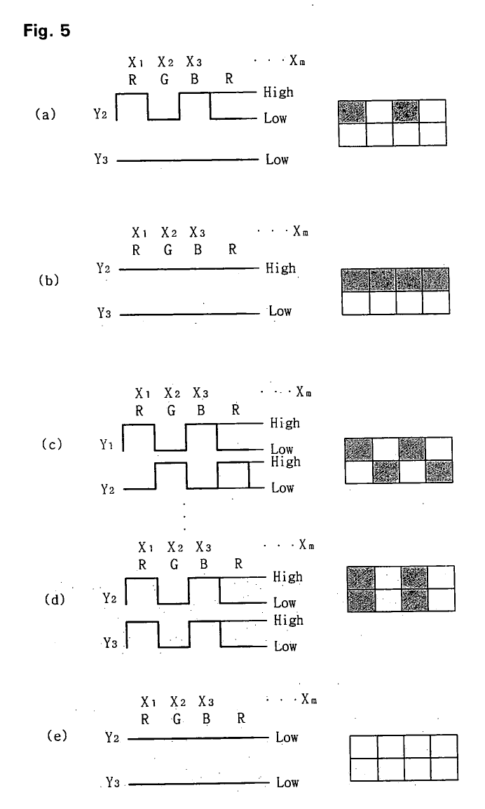

An important factor to decide one of the plurality of scan types is the amount of a displacement current (Id) depending on image data. This will be described below with reference to FIG. 5.

FIG. 5 is a view illustrating the amount of the displacement current according to input image data.

Referring to FIG. 5, as in (a), when a second scan electrode Y2 is scanned, i.e., when a scan pulse is supplied to the second scan electrode Y2, data electrodes, such as data electrodes X1 to Xm, are supplied with image data in which a logic value of 1 (high) and 0 (low) is alternated. Furthermore, when a third scan electrode Y3 is scanned, the data electrodes X are kept to the logic value 0. The logic value 1 is a state where a voltage of the data pulse, i.e., a state where a data voltage (Vd) is applied to a corresponding data electrode X. The logic value 0 is a state where 0V is applied to a corresponding data electrode X, i.e., a state where the data voltage (Vd) is not applied.

That is, image data in which a logic value is alternated between 1 and 0 is applied to a discharge cell on one scan electrode Y. Image data that are maintained to the logic value 0 are applied to a discharge cell on a next scan electrode Y. The displacement current (Id) flowing through each of the data electrodes X can be expressed in the following Equation 1.
Id=1/2(Cm1+Cm2)Vd [Equation 1]

Id: Displacement current flowing through each of the data electrodes X

Cm1: Equivalent capacitance between the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

As in (b), when the second scan electrode Y2 is scanned, image data whose logic value is kept to 1 are supplied to the data electrodes X1 to Xm. Furthermore, when the third scan electrode Y3 is scanned, image data whose logic value is kept to 0 are supplied to the data electrodes X1 to Xm. The logic value 0 is a state where 0V is applied to corresponding data electrodes X, i.e., a state where the data voltage (Vd) is not applied, as described above.

That is, this is a case where image data whose logic value is kept to 1 are supplied to a discharge cell on one scan electrode Y and image data whose logic value is kept to 0 are supplied to a discharge cell on a next scan electrode Y. This is also true of a case where image data whose logic value is kept to 0 are supplied to a discharge cell on one scan electrode Y and image data whose logic value is kept to 1 are supplied to a discharge cell on a next scan electrode Y.

The displacement current (Id) flowing through each of the data electrodes X can be expressed in the following Equation 2.
Id=1/2(Cm2)Vd [Equation 2]

Id: Displacement current flowing through each of the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

As in (c), when the second scan electrode Y2 is scanned, image data whose logic value is alternately changed between 1 and 0 are supplied to the data electrodes X1 to Xm. Furthermore, when the third scan electrode Y3 is scanned, image data whose logic value is alternately changed between 1 and 0 are supplied so that the image data have a phase, which is shifted by 180° from the phase of the image data applied to the discharge cell on the second scan electrode Y2.

That is, image data whose logic value is alternately changed between 1 and 0 are supplied to a discharge cell on one scan electrode Y. Image data whose logic value is alternately changed between 1 and 0 are supplied to a discharge cell on a next scan electrode Y so that the image data have a phase, which is shifted by 180° from the phase of the image data applied to the discharge cell on one scan electrode Y.

The displacement current (Id) flowing through each of the data electrodes X can be expressed in the following Equation 3.
Id=1/2(4Cm1+Cm2)Vd [Equation 3]

Id: Displacement current flowing through each of the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

As in (d), when the second scan electrode Y2 is scanned, image data whose logic value is alternately changed between 1 and 0 are supplied to the data electrodes X1 to Xm. Furthermore, when the third scan electrode Y3 is scanned, image data whose logic value is alternately changed between 1 and 0 are supplied so that the image data have the same phase as that of the image data applied to the discharge cell on the second scan electrode Y2.

That is, the image data whose logic value is alternately changed between 1 and 0 are supplied to the discharge cell on one scan electrode Y. The image data whose logic value is alternately changed between 1 and 0 are supplied to a discharge cell on a next scan electrode Y so that the image data have the same phase as that of the image data applied to the discharge cell on one scan electrode Y.

At this time, the displacement current (Id) flowing through each of the data electrodes X can be expressed in the following Equation 4
Id=0 [Equation 4]

Id: Displacement current flowing through each of the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

As in (e), when the second scan electrode Y2 is scanned, image data whose logic value is kept to 0 are supplied to the data electrodes X1 to Xm. Furthermore, when the third scan electrode Y3 is scanned, image data whose logic value is kept to 0 are also supplied to the data electrodes X1 to Xm.

That is, image data whose logic value is kept to 0 are supplied to a discharge cell on one scan electrode Y, and image data whose logic value is kept to 0 are supplied to a discharge cell on a next scan electrode Y.

Furthermore, this is true of a case where image data whose logic value is kept to 1 are supplied to a discharge cell on one scan electrode Y and image data whose logic value is kept to 1 are supplied to a discharge cell on a next scan electrode Y.

At this time, the displacement current (Id) flowing through each of the data electrodes X can be expressed in the following Equation 5.
Id=0 [Equation 5]

Id: Displacement current flowing through each of the data electrodes X.

Cm2: Equivalent capacitance between the data electrodes X and the scan electrodes Y or between the data electrodes X and the sustain electrodes Z

Vd: Voltage of the data pulse, which is applied to each of the data electrodes X

From Equations 1 to 5, it can be seen that a case where image data whose logic value is alternately changed between 1 and 0 are supplied to the discharge cell on one scan electrode Y and image data whose logic value is alternately changed between 1 and 0 are supplied to a discharge on a next scan electrode Y so that the image data have a phase, which is shifted by 180° from a phase of the image data applied to the discharge cell on one scan electrode Y has the highest displacement current flowing through the data electrodes X.

Meanwhile, it can be seen that a case where image data whose logic value is alternately changed between 1 and 0 are supplied to a discharge cell on one scan electrode Y and image data whose logic value is alternately changed between 1 and 0 are supplied to a discharge cell on a next scan electrode Y so that the image data have the same phase as that of the image data applied to the discharge cell on one scan electrode Y, and a case where image data whose logic value is kept to 0 are supplied both to a discharge cell on one scan electrode Y and a discharge cell on a next scan electrodes Y have the lowest displacement current flowing through the data electrodes X.

From the description of FIG. 5, it can be seen that, in the case where image data having a different logic level are alternately supplied as in FIG. 5(c), the highest displacement current flows, and a possibility that the data driver IC can experience the greatest electrical damage is the highest in this case.

In other words, from the viewpoint of the data driver IC responsible for one data electrode X, the image data as shown in FIG. 5(c) correspond to a case where the switching number of the data driver IC is the highest. Therefore, it can be seen that the greater the switching operation number of the data driver IC, the more the displacement current flowing through the data driver IC and the higher the possibility that the data driver IC may undergo electrical damage.

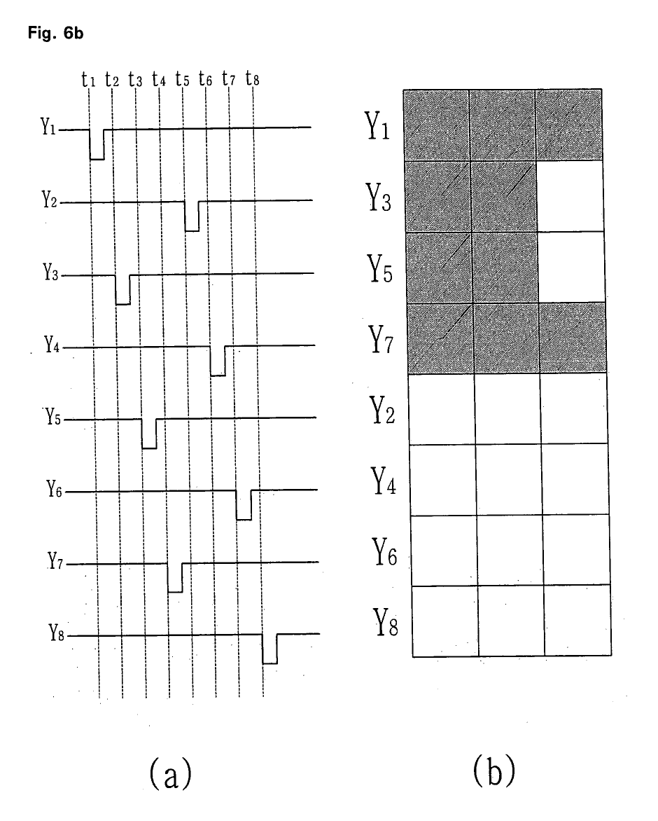

An example of changing the scan order considering these image data and the amount of the displacement current accordingly will be described with reference to FIGS. 6a and 6b.

FIGS. 6a and 6b are views illustrating an exemplary method of changing a scan order considering image data and a displacement current accordingly.

From FIGS. 6a and 6b, it can be seen that FIGS. 6a and 6b show the same image data except for its scan order, i.e., a scanning order.

Referring first to FIG. 6a, in the case where image data of a pattern as shown in (b) are supplied, if the scan electrodes Y are scanned in the same order as that of (a), a relatively high displacement current is generated because the frequency that a logic value of image data is changed in a direction where the scan electrodes Y are arranged is relatively frequent.

If the scanning order of the scan electrodes Y is again adjusted as in (a) of FIG. 6b, it results in that the image data of this pattern are arranged as shown in (b) of FIG. 6b. In this case, since the frequency that the logic value of image data is changed in a direction where the scan electrodes Y are arranged is reduced, a displacement current generated is reduced.

As a result, if the scanning order of the scan electrodes Y is controlled according to the image data as in FIG. 6b, the amount of the displacement current flowing through the data driver IC can be reduced and a possibility that the data driver IC may experience electrical damage is reduced.

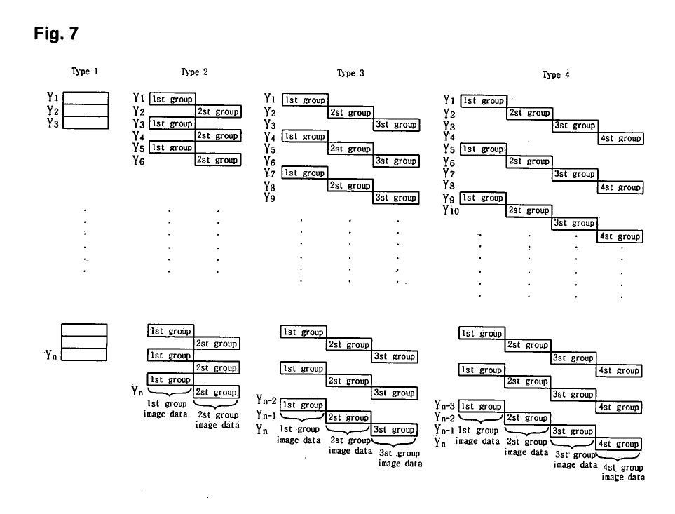

The method of driving the plasma display apparatus according to the present invention has been developed on the basis of the principle as in FIGS. 6a and 6b. Another example in the method of driving the plasma display apparatus according to the present invention will be described with reference to FIG. 7.

FIG. 7 is a view illustrating another example in a driving method of a plasma display apparatus according to the present invention.

Referring to FIG. 7, the method of driving the plasma display apparatus according to the present invention can perform scanning using a selected one of four scan types, i.e., a first type (Type 1), a second type (Type 2), a third type (Type 3) and a fourth type (Type 4), as shown in FIG. 7.

In the scan order of the first scan type (Type 1), scanning is performed in an order in which scan electrodes Y are arranged like Y1-Y2-Y3- . . .

In the scan order of the second scan type (Type 2), scan electrodes Y belonging to a first group are sequentially scanned, and scan electrodes Y belonging to a second group are sequentially scanned. That is, the scan electrodes Y1-Y3-Y5-, . . . , Yn−1 are scanned and the scan electrodes Y2-Y4-Y6-, . . . , Yn are scanned.

In the scan order of the third scan type (Type 3), after scan electrodes Y belonging to a first group are sequentially scanned and scan electrodes Y belonging to a second group are sequentially scanned, scan electrodes Y belonging to a third group are sequentially scanned. That is, after the scan electrodes Y1-Y4-Y7-, . . . , Yn−2 are scanned and the scan electrodes Y2-Y5-Y8-, . . . , Yn−1 are scanned, the scan electrodes Y3-Y6-Y9-, . . . , Yn are scanned.

In the scan order of the fourth scan type (Type 4), after scan electrodes Y belonging to a first group are sequentially scanned, scan electrodes Y belonging to a second group are sequentially scanned and scan electrodes Y belonging to a third group are sequentially scanned, scan electrodes Y belonging to a fourth group are sequentially scanned. That is, after scan electro Y1-Y5-Y9-, . . . , Yn−3 are scanned, scan electrodes Y2-Y6-Y10-, . . . , Yn−2 are scanned, scan electrodes Y3-Y7-Y11-, . . . , Yn−1 are scanned, scan electrodes Y4-Y8-Y12-, . . . , Yn are scanned.

In FIG. 7, the method of scanning the scan electrodes Y using a selected one of the four kinds of scan types has been shown. However, the present invention is not limited to the above method. A method of scanning the scan electrodes Y using a selected one of various numbers of scan types, such as two kinds of scan types, three kinds of scan types and five kinds of scan types, is also possible.

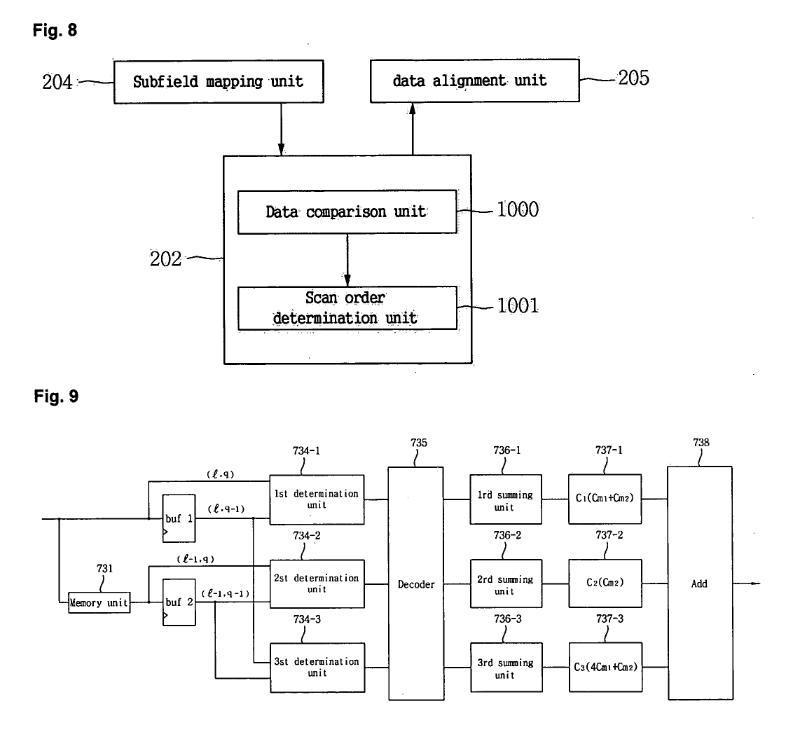

A detailed construction of the scan driver 202 shown in FIG. 2, for scanning the scan electrodes Y using one of a plurality of scan types as described above, will be described with reference to FIG. 8.

FIG. 8 is a view illustrating the construction and operation of the scan driver for realizing the method of driving the plasma display apparatus according to the present invention.

Referring to FIG. 8, the scan driver for implementing the method of driving the plasma display apparatus according to the present invention can comprise a data comparator 1000 and a scan order decision unit 1001.

The data comparator 1000 receives image data, which are mapped by the sub-field mapping unit 204, and calculates the amount of the displacement current by comparing image data of a cell bundle consisting of one or more discharge cells located on a specific scan electrode Y line and image data of a cell bundle located in vertical and horizontal directions of the cell bundle using a plurality of scan types.

The term “cell bundle” refers to that one or more cells are bundled to form one unit. For example, since cells corresponding to R, G, and B are bundled to form one pixel, a pixel corresponds to the cell bundle.

The scan order decision unit 1001 decides a scan order using a scan type having the lowest displacement current based on information on the amount of the displacement current, which is calculated by the data comparator 1000.

Information on the scan order, which is decided by the scan order decision unit 1001, is applied to the data aligner 205. The data aligner 205 realigns the image data, which are sub-field mapped by the sub-field mapping unit 204 according the scan order decided by the above-described scan order decision unit 1001, and supplies the re-aligned image data to the data electrodes X.

The construction of the scan driver 202 shown in FIG. 8 will be described in conjunction with FIG. 7. If amounts of the displacement current with respect to the four kinds of the scan types in FIG. 7 are calculated by the data comparator 1000 of FIG. 8 and information on the amounts of the displacement current with respect to the four kinds of the scan types is applied to the scan order decision unit 1001, the scan order decision unit 1001 compares the amounts of the displacement current with respect to the four kinds of the scan types, and selects one scan type having the lowest displacement current. For example, assuming that the amount of the displacement current with respect to the first scan type is 10, the amount of the displacement current the amount the second scan type is 15, the amount of the displacement current for the third scan type is 1 and the amount of the displacement current for the fourth scan type is 8, the scan order decision unit 1001 selects the fourth scan type and decides a scanning order of the scan electrodes Y according to the selected fourth scan type.

Meanwhile, if amounts of the displacement current with respect to all the scan types of the four kinds of scan types, i.e., the first, third and fourth scan types other than the second scan type is sufficiently low so that it does not cause electrical damage to the data driver IC, the scan order decision unit 1001 can select any one of the first, third and fourth scan types.

In this case, information on current, which is sufficiently low enough not to cause electrical damage to the data driver IC, can be previously set. That is, the highest value of current, which is sufficiently low enough not to cause electrical damage to the data driver IC, is previously set as a critical current. A scan type in which a displacement current lower than the critical current is generated can be selected.

The data comparator 100 shown in FIG. 8 will be described in more detail below with reference to FIG. 9.

FIG. 9 shows a basic circuit block included in a data comparator 1000, which is included in the scan driver of the plasma display apparatus according to the present invention.

As shown in FIG. 9, in the plasma display apparatus of the present invention, the basic circuit block included in the data comparator 1000 of the scan driver comprises a memory unit 731, a first buffer buf1, a second buffer buf2, first to third decision units 734-1, 734-2 and 734-3, a decoder 735, first to third summation units 736-1, 736-2 and 736-3, first to third current calculators 737-1, 737-2 and 737-3, and a current summation unit 738.

Image data corresponding to a (l−1)^{th} scan electrode, i.e., a (l−1)^{th} scan electrode line are stored in the memory unit 731. Image data corresponding to a l^{th} scan electrode, i.e., a l^{th} scan electrode line are input.

The first buffer buf1 temporarily stores the image data of a (q−1)^{th} discharge cell of discharge cells corresponding to the l^{th} scan electrode line.

The second buffer buf2 temporarily stores the image data of a (q−1)^{th} discharge cell of discharge cells corresponding to the (l−1)^{th} scan electrode line, which are stored in the memory unit 731.

The first decision unit 734-1 comprises an XOR gate element, and it compares the image data of a q^{th} discharge cell of the l^{th} scan electrode line and the image data of the (q−1)^{th} discharge cell of the l^{th} scan electrode line, which are stored in the first buffer buf1. As a result of the comparison, if the two image data are different from each other, the first decision unit 734-1 outputs 1. If the two image data are identical to each other, the first decision unit 734-1 outputs 0.

The second decision unit 734-2 comprises an XOR gate element, and it compares the image data of the q^{th} discharge cell of the (l−1)^{th} scan electrode line and the image data of the (q−1)^{th} discharge cell of the (l−1)^{th} scan electrode line, which are stored in the second buffer buf2. As a result of the comparison, if the two image data are different from each other, the second decision unit 734-2 outputs 1. If the two image data are identical to each other, the second decision unit 734-2 outputs 0.

The third decision unit 734-3 comprises an XOR gate element, and it compares the image data of the (q−1)^{th} discharge cell of the l^{th} scan electrode line, which are stored in the first buffer buf1, and the image data of the (q−1)^{th} discharge cell of the (l−1)^{th} scan electrode line, which are stored in the second buffer buf2. As a result of the comparison, if the two image data are different from each other, the third decision unit 734-3 outputs 1. If the two image data are identical to each other, the third decision unit 734-3 outputs 0.

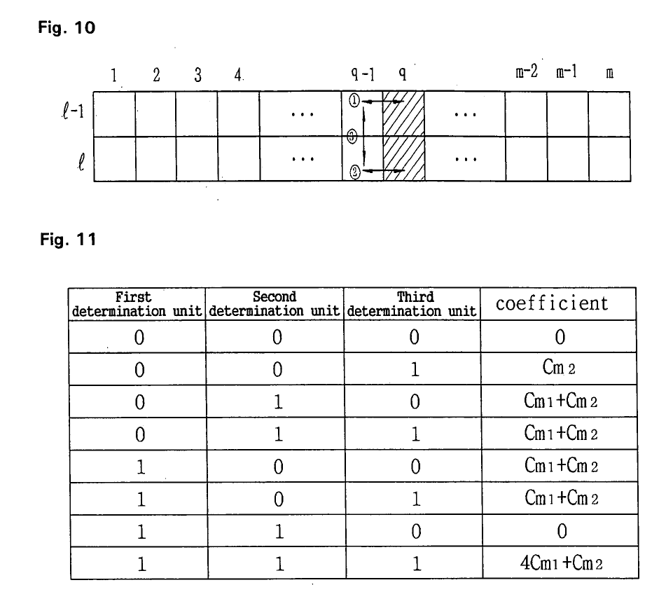

The operation of the first to third decision units included in the basic circuit block of the data comparator 1000 constructed above will be described in more detail below with reference to FIG. 10.

FIG. 10 is a view illustrating, in more detail, the operation of the first to third decision units of the data comparator. □, □ and □ correspond to the operations of the first decision unit 734-1, the second decision unit 734-2 and the third decision unit 734-3.

Referring to FIG. 10, the data comparator 1000 of the present invention compares image data of neighing cells located in horizontal and vertical directions of one cell using the first decision unit 734-1 to the third decision unit 734-3, and determines variation in the image data.

The decoder 735 outputs a 3-bit signal corresponding to an output signal of each of the first to third decision units 734-1, 734-2 and 734-3.

FIG. 11 is a table showing pattern contents of the image data according to the output signals of the first to third decision units 734-1, 734-2 and 734-3 included in the basic circuit block of the data comparator according to the present invention.

Referring to FIG. 11, if an output signal of each of the first to third decision units 734-1, 734-2 and 734-3 is (0,0,0), this is the same as the pattern state of the image data shown in (a) of FIG. 5. If the output signal is (0,0,0), the displacement current (Id) is 0.

If the output signal of each of the first to third decision units 734-1, 734-2 and 734-3 is (0,0,1), this is the same as the pattern state of the image data, which is shown in (b) of FIG. 5. Therefore, if the output signal is (0,0,1), the displacement current (Id) is proportional to Cm2.

If the output signal of each of the first to third decision units 734-1, 734-2 and 734-3 is any one of (0,1,0), (0,1,1), (1,0,0) and (1,0,1), this is the same as the pattern state of the image data, which is shown in (a) of FIG. 5. Therefore, if the output signal is any one of (0,1,0), (0,1,1), (1,0,0) and (1,0,1), the displacement current (Id) is proportional to (Cm1+Cm2).

If the output signal of each of the first to third decision units 734-1, 734-2 and 734-3 is (1,1,0), this is the same as the pattern state of the image data, which is shown in (d) of FIG. 5. Therefore, if the output signal is (1,1,0), the displacement current (Id) is 0.

If the output signal of each of the first to third decision units 734-1, 734-2 and 734-3 is (1,1,1), this is the same as the pattern state of the image data, which is shown in (c) of FIG. 5. Therefore, if the output signal is (1,1,1), the displacement current (Id) is proportional to (4Cm1+Cm2).

Furthermore, the first to third summation units 736-1, 736-2 and 736-3 of FIG. 9 sum output numbers of specific 3-bit signals output from the decoder 735, and output the summation result.

That is, the first summation unit 736-1 sums a number in which any one of (0,1,0), (0,1,1), (1,0,0) and (1,0,1) is output by the decoder 735 (C1). The second summation unit 736-2 sums a number in which (0,0,1) is output by the decoder 735 (C2). The third summation unit 736-3 sums a number in which (1,1,1) is output by the decoder 735 (C3).

The first to third current calculators 737-1, 737-2 and 737-3 receive C1, C2 and C3 from the first summation unit 736-1, the second summation unit 736-2 and the third summation unit 736-3, respectively, and calculate amounts of the displacement current.

The current summation unit 738 sums the amounts of the displacement current, which are calculated by the first to third current calculators 737-1, 737-2 and 737-3.

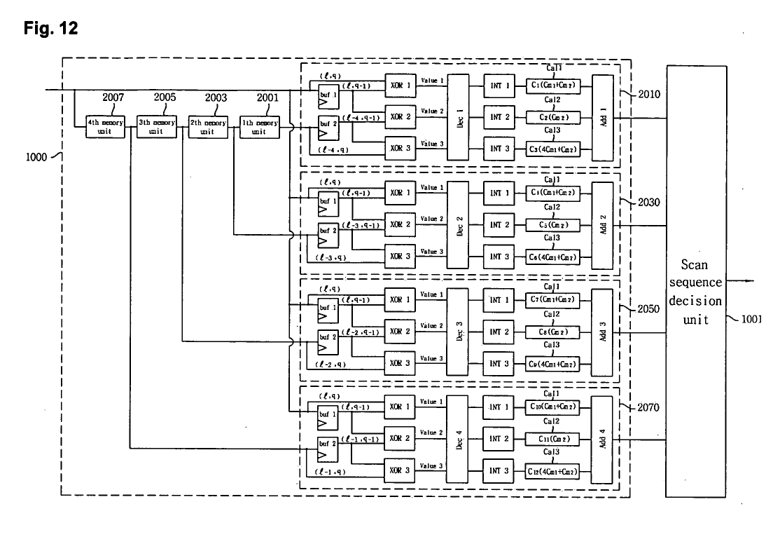

FIG. 12 is a block diagram of the data comparator 1000 and the scan order decision unit 1001 of the scan driver in the plasma display apparatus according to the present invention.

As shown in FIG. 12, in the plasma display apparatus of the present invention, the data comparator 1000 of the scan driver has a structure in which four basic circuit blocks shown in FIG. 12 are connected. The scan order decision unit 1001 compares the outputs of the four basic circuit blocks to decide a scan order that outputs the lowest displacement current. FIG. 12 corresponds to a case where a scan type includes a total of four scan types as shown in FIG. 7. That is, FIG. 12 shows the construction of the data comparator 1000 and the scan order decision unit 1001 corresponding to the case where the scan electrodes Y are scanned from the total of four scan types to one scan type.

The data comparator 1000 comprises first to fourth memory units 2001, 2003, 2005 and 2007, and first to fourth current decision units 2010, 2030, 2050 and 2070. That is, one memory unit and one current decision unit correspond to the basic circuit block shown in FIG. 12.

The first to fourth memory units 2001, 2003, 2005 and 2007 are interconnected and store image data corresponding to the four scan electrode (Y) lines. That is, the first memory unit 2001 stores image data corresponding to a (l−4)^{th} scan electrode (Y) line. The second memory unit 2003 stores image data corresponding to a (l−3)^{th} scan electrode (Y) line. The third memory unit 2005 stores image data corresponding to a (l−2)^{th} scan electrode (Y) line. The fourth memory unit 907 stores image data corresponding to a (l−1)^{th} scan electrode (Y) line.

The first current decision unit 2010 receives the image data of the l^{th} scan electrode (Y) line and the image data of the (l−4)^{th} scan electrode (Y) line, which are stored in the first memory unit 2001. If the current of the first current decision unit 2010 that has received the image data is lower than that of the second to fourth current decision units 2030, 2050 and 2070, a scan order is the same as the fourth scan type (Type 4) of FIG. 7. That is, scanning has to be performed in order of Y1-Y5-Y9-, . . . , Y2-Y6-Y10-, . . . , Y3-Y7-Y11-, . . . , Y4-Y8-Y12-, . . . .

The operation of the first current decision unit 2010 is the same as that of the above basic circuit block. The image data corresponding to the (l−4)^{th} scan electrode (Y) line are stored in the first memory unit 2001, and the image data corresponding to the l^{th} scan electrode (Y) line are input.

The first buffer buf1 temporarily stores the image data of the (q−1)^{th} discharge cell of the discharge cells corresponding to the l^{th} scan electrode (Y) line.

The second buffer buf2 temporarily stores the image data of the (q−1)^{th} discharge cell of the discharge cells corresponding to the (l−4)^{th} scan electrode (Y) line, which are stored in the first memory unit 2001.

The first decision unit XOR1 comprises an XOR gate element, and it compares image data (l, q) of the q^{th} discharge cell of the l^{th} scan electrode (Y) line and image data (l, q−1) of the (q−1)^{th} discharge cell of the l^{th} scan electrode (Y) line, which are stored in the first buffer buf1. As a result of the comparison, if the two data are different from each other, the first decision unit XOR1 outputs Value=1. If the two data are identical to each other, the first decision unit XOR outputs Value=0.

The second decision unit XOR2 comprises an XOR gate element, and it compares image data (l, q−1) of the (q−1)^{th} discharge cell of the l^{th} scan electrode (Y) line and image data (l−4, q−1) of the (q−1)^{th} discharge cell of the (l−4)^{th} scan electrode (Y) line, which are stored in the second buffer buf2. As a result of the comparison, if the two data are different from each other, the second decision unit XOR2 outputs Value=1. If the two data are identical to each other, the first decision unit XOR1 outputs Value=0.

The third decision unit XOR3 comprises an XOR gate element, and it compares image data (l−4, q−1) of the (q−1)^{th} discharge cell of the (q−4)^{th} scan electrode (Y) line, which are stored in the second buffer buf2, and image data (l−4, q) of the q^{th} discharge cell of the (l−4)^{th} scan electrode (Y) line, which are output from the first memory unit 901. As a result of the comparison, if the two data are different from each other, the third decision unit XOR3 outputs Value=1. If the two data are identical to each other, the first decision unit XOR1 outputs Value=0.

The first decoder Dec1 receives the output signals of the first to third decision units XOR1, XOR2 and XOR3 in parallel and then outputs 3-bit signals.

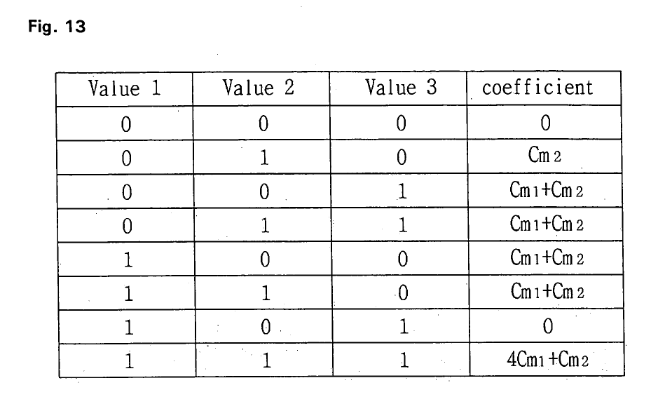

FIG. 13 is a table showing the pattern contents of the image data depending on the output signals of the first to third decision units XOR1, XOR2 and XOR3 included in the data comparator according to the present invention.

Referring to FIG. 13, amounts of capacitance that decides amounts of displacement currents are varied depending on output signals (Value1, Value2, Value3) of the first to third decision units XOR1, XOR2 and XOR3.

First to third summation units Int1, Int2 and Int3 sum output numbers of specific 3-bit signals, which are output from the first decoder Dec1, and output the sum results.

That is, the first summation unit Int1 sums (C1) a number in which any one of (0,0,1), (0,1,1), (1,0,0) and (1,1,0) is output by the first decoder Dec1. The second summation unit Int2 sums (C2) a number in which (0,1,0) is output by the first decoder Dec1. The third summation unit Int3 sums (C3) a number in which (1,1,1) is output by the first decoder Dec1.

First to third current calculators Cal1, Cal2, Cal3 receive C1, C2 and C3 from the first summation units Int1, the second summation unit Int2 and the third summation unit Int3, respectively, and calculate amounts of the displacement current.

That is, the first current calculator Cal1 calculates the amount of current by multiplying the output (C1) of the first summation unit Int1 and (Cm1+Cm2). The second current calculator Cal2 calculates the amount of current by multiplying the output (C2) of the second summation unit Int2 and Cm2. The third current calculator Cal3 calculates the amount of current by multiplying the output (C3) of the third summation unit Int3 and (4Cm1+Cm2).

A first current summation unit Add1 sums the amounts of the displacement current, which are calculated by the first to third current calculators Cal1, Cal2 and Cal3.

In the same manner as the operation of the first current decision unit, the second to fourth current decision units 2030, 2050 and 2070 calculate the summed amounts of the displacement current.

The first decision unit XOR1 of the second current decision unit 2030 comprises an XOR gate element, and it compares the image data (l, q) of the q^{th} discharge cell of the l^{th} scan electrode (Y) line and the image data (l, q−1) of the (q−1)^{th} discharge cell of the l^{th} scan electrode (Y) line, which are stored in the first buffer buf1. As a result of the comparison, if the two image data are different from each other, the first decision unit XOR1 outputs 1. If the two image data are identical to each other, the first decision unit XOR1 outputs 0.

The second decision unit XOR2 of the second current decision unit 2030 comprises an XOR gate element, and it compares the image data (l, q−1) of the (q−1)^{th} discharge cell of the l^{th} scan electrode (Y) line and the image data (l−3, q−1) of the (q−1)^{th} discharge cell of the (l−3)^{th} scan electrode (Y) line, which are stored in the second buffer buf2. As a result of the comparison, if the two image data are different from each other, the second decision unit XOR2 outputs 1. If the two image data are identical to each other, the second decision unit XOR2 outputs 0.

The third decision unit XOR3 of the second current decision unit 2030 comprises an XOR gate element, and it compares the image data (l−3, q−1) of the (q−1)^{th} discharge cell of the (l−3)^{th} scan electrode (Y) line, which are stored in the second buffer buf2, and the image data (l−3, q) of the q^{th} discharge cell of the (l−3)^{th} scan electrode (Y) line, which are output the second memory unit 2003. As a result of the comparison, if the two image data are different from each other, the third decision unit XOR3 outputs 1. If the two image data are identical to each other, the third decision unit XOR3 outputs 0.

Furthermore, the first decision unit XOR1 of the third current decision unit 2050 comprises an XOR gate element, and it compares the image data (l, q) of the q^{th} discharge cell of the l^{th} scan electrode (Y) line and the image data (l, q−1) of the (q−1)^{th} discharge cell of the l^{th} scan electrode (Y) line, which are stored in the first buffer buf1. As a result of the comparison, if the two image data are different from each other, the first decision unit XOR1 outputs 1. If the two image data are identical to each other, the first decision unit XOR1 outputs 0.

The second decision unit XOR2 of the third current decision unit 2050 comprises an XOR gate element, and it compares the image data (l, q−1) of the (q−1)^{th} discharge cell of the l^{th} scan electrode (Y) line and the image data (l−2, q−1) of the (q−1)^{th} discharge cell of the (l−2)^{th} scan electrode (Y) line, which are stored in the second buffer buf2. As a result of the comparison, if the two image data are different from each other, the second decision unit XOR2 outputs 1. If the two image data are identical to each other, the second decision unit XOR2 outputs 0.

The third decision unit XOR3 of the third current decision unit 2050 comprises an XOR gate element, and it compares the image data (l−2, q−1) of the (q−1)^{th} discharge cell of the (l−2)^{th} scan electrode (Y) line, which are stored in the second buffer buf2, and the image data (l−2, q) of the q^{th} discharge cell of the (l−2)^{th} scan electrode (Y) line, which are output from the third memory unit 2005. As a result of the comparison, if the two image data are different from each other, the third decision unit XOR3 outputs 1. If the two image data are identical to each other, the third decision unit XOR3 outputs 0.

The first decision unit XOR1 of the fourth current decision unit 2070 comprises an XOR gate element, and it compares the image data (l, q) of the q^{th} discharge cell of the l^{th} scan electrode (Y) line and the image data (l, q−1) of the (q−1)^{th} discharge cell of the l^{th} scan electrode (Y) line, which are stored in the first buffer buf1. As a result of the comparison, if the two image data are different from each other, the first decision unit XOR1 outputs 1. If the two image data are identical to each other, the first decision unit XOR1 outputs 0.

The second decision unit XOR2 of the fourth current decision unit 2070 comprises an XOR gate element, and it compares the (q−1)^{th} image data (l, q−1) of the l^{th} scan electrode (Y) line and the image data (l−1, q−1) of the (q−1)^{th} discharge cell of the (l−1)^{th} scan electrode (Y) line, which are stored in the second buffer buf2. As a result of the comparison, if the two image data are different from each other, the second decision unit XOR2 outputs 1. If the two image data are identical to each other, the second decision unit XOR2 outputs 0.

The third decision unit XOR3 of the fourth current decision unit 2070 comprises an XOR gate element, and it compares the image data (l−1, q−1) of the (q−1)^{th} discharge cell of the (l−1)^{th} scan electrode (Y) line, which are stored in the second buffer buf2, and the image data (l−1, q) of the q^{th} discharge cell of the (l−1)^{th} scan electrode (Y) line, which are output from the fourth memory unit 2007. As a result of the comparison, if the two image data are different from each other, the third decision unit XOR3 outputs 1. If the two image data are identical to each other, the third decision unit XOR3 outputs 0.

The scan order decision unit 1001 receives the amounts of the displacement current, which are calculated by the first to fourth current decision units 2010, 2030, 2050 and 2070, and then decides a scan order according to a current decision unit that has output the lowest displacement current, or decides a scan order of the scan electrodes Y according to any one of the scan types, in which a displacement current lower than a previously set critical current is generated.

For example, if the scan order decision unit 1001 determines that the amount of the displacement current received from the second current decision unit 2030 is the lowest, the scan order decision unit 1001 sets a scan order so that scanning is performed in order of Y1-Y4-Y7-, . . . , Y2-Y5-Y8-, . . . , Y3-Y6-Y9-, . . . , in the same manner as the third scan type (Type 3) of FIG. 9.

Furthermore, if the scan order decision unit 1001 determines that the amount of the displacement current received from the third current decision unit 2050 is the lowest, the scan order decision unit 1001 sets the scan order so that scanning is performed in order of Y1-Y3-Y5-, . . . , Y2-Y4-Y6-, . . . , in the same manner as the second scan type (Type 2) of FIG. 9.

If the scan order decision unit 1001 determines that the amount of the displacement current received from the fourth current decision unit 2070 is the lowest, the scan order decision unit 1001 sets the scan order so that scanning is performed in order of Y1-Y2-Y3-Y4-Y5-Y6-, . . . , in the same manner as the first scan type (Type 1) of FIG. 9.

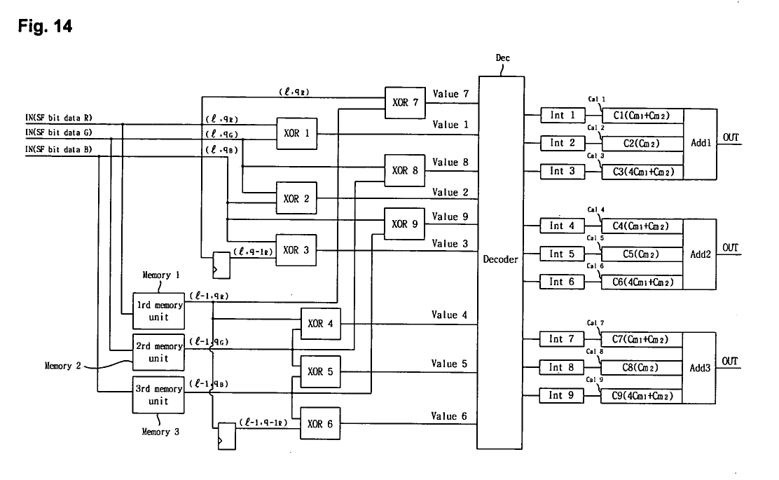

Meanwhile, in the plasma display apparatus of the present invention, which has been described with reference to FIG. 9, the basic circuit block included in the data comparator 1000 of the scan driver can be constructed differently from that of FIG. 9. This will be described below with reference to FIG. 14.

FIG. 14 is a block diagram illustrating another construction of the basic circuit block included in the data comparator 1000, which is included in the scan driver of the plasma display apparatus according to the present invention.

Referring to FIG. 14, the basic circuit block of FIG. 14 calculates the amount of the displacement current through variation in image data corresponding to R, G and B cells of a q^{th} pixel and a (q−1)^{th} pixel on the l^{th} scan electrode line, variation in image data corresponding to R, G and B cells of the q^{th} pixel and the (q−1)^{th} pixel on the (l−1) scan line, and variation in image data corresponding to R, G and B cells of the q^{th} pixel on the l^{th} scan electrode line and the (q−1)^{th} pixel on the (l−1)^{th} scan electrode line.

First to third memory units Memory1, Memory2 and Memory3 temporarily store the image data corresponding to the R cell of the (l−1)^{th} scan electrode line, the image data corresponding to the G cell of the (l−1)^{th} scan electrode line, and the image data corresponding to the B cell of the (l−1)^{th} scan electrode line, respectively.

The first to third decision units XOR1, XOR2 and XOR3 decide variation between the image data corresponding to the R, G and B cells of the q^{th} pixel on the l^{th} scan electrode line.

That is, the first decision unit XOR1 compares image data (l, qR) corresponding to the R cell of the q^{th} pixel on the l^{th} scan electrode line and image data (l, qG) corresponding to the G cell of the q^{th} pixel on the l^{th} scan electrode line. As a result of the comparison, if the two data are different from each other, the first decision unit XOR1 outputs the logic value 1. If the two data are identical to each other, the first decision unit XOR1 outputs the logic value 0.

The second decision unit XOR2 compares image data (l, qG) corresponding to the G cell of the q^{th} pixel on the l^{th} scan electrode line and image data (l, qB) corresponding to the B cell of the q^{th} pixel on the l^{th} scan electrode line. As a result of the comparison, if the two data are different from each other, the second decision unit XOR2 outputs the logic value 1. If the two data are identical to each other, the first decision unit XOR1 outputs the logic value 0.

The third decision unit XOR3 compares image data (l, qB) corresponding to the B cell of the q^{th} pixel on the l^{th} scan electrode line and image data (l, q−1R) corresponding to the R cell of the (q−1)^{th} pixel on the l^{th} scan electrode line. As a result of the comparison, if the two data are different from each other, the third decision unit XOR3 outputs the logic value 1. If the two data are identical to each other, the first decision unit XOR1 outputs the logic value 0.

The fourth to sixth decision units XOR4, XOR5 and XOR6 decide variation between the image data corresponding to the R, G and B cells of the q^{th} pixel on the (l−1)^{th} scan electrode line.

That is, the fourth decision unit XOR4 compares image data (l−1, qR) corresponding to the R cell of the q^{th} pixel on the (l−1)^{th} scan electrode line and image data (l−1, qG) corresponding to the G cell of the q^{th} pixel on the (l−1)^{th} scan electrode line. As a result of the comparison, if the two data are different from each other, the fourth decision unit XOR4 outputs the logic value 1. If the two data are identical to each other, the first decision unit XOR1 outputs the logic value 0.

The fifth decision unit XOR5 compares image data (l−1, qG) corresponding to the G cell of the q^{th} pixel on the (l−1)^{th} scan electrode line and image data (l−1, qB) corresponding to the B cell of the q^{th} pixel on the (l−1)^{th} scan electrode line. As a result of the comparison, if the two data are different from each other, the fifth decision unit XOR5 outputs the logic value 1. If the two data are identical to each other, the first decision unit XOR1 outputs the logic value 0.

The sixth decision unit XOR6 compares image data (l−1, qB) corresponding to the B cell of the q^{th} pixel on the (l−1)^{th} scan electrode line and image data (l−1, q−1 R) corresponding to the R cell of the (q−1)^{th} pixel on the (l−1)^{th} scan electrode line. As a result of the comparison, if the two data are different from each other, the sixth decision unit XOR6 outputs the logic value 1. If the two data are identical to each other, the first decision unit XOR1 outputs the logic value 0.

The seventh to ninth decision units XOR7, XOR8 and XOR9 decide variation between the image data by comparing the image data corresponding to the R, G and B cells of the q^{th} pixel on the l^{th} scan electrode line and the image data corresponding to the R, G and B cells of the q^{th} pixel on the (l−1)^{th} scan electrode line, respectively.

That is, the seventh decision unit XOR7 compares the image data (l, qR) corresponding to the R cell of the q^{th} pixel on the l^{th} scan electrode line and the image data (l−1, qR) corresponding to the R cell of the q^{th} pixel on the (l−1)^{th} scan electrode line. As a result of the comparison, if the two data are different from each other, the seventh decision unit XOR7 outputs the logic value 1. If the two data are identical to each other, the first decision unit XOR1 outputs the logic value 0.

The eighth decision unit XOR8 compares the image data (l, qG) corresponding to the G cell of the q^{th} pixel on the l^{th} scan electrode line and the image data (l−1, qG) corresponding to the G cell of the q^{th} pixel on the (l−1)^{th} scan electrode line. As a result of the comparison, if the two data are different from each other, the eighth decision unit XOR8 outputs the logic value 1. If the two data are identical to each other, the first decision unit XOR1 outputs the logic value 0.

The ninth decision unit XOR9 compares the image data (l, qB) corresponding to the B cell of the q^{th} pixel on the l^{th} scan electrode line and the image data (l−1, qB) corresponding to the B cell of the q^{th} pixel on the (l−1)^{th} scan electrode line. As a result of the comparison, if the two data are different from each other, the ninth decision unit XOR9 outputs the logic value 1. If the two data are identical to each other, the first decision unit XOR1 outputs the logic value 0.

The decoder Dec outputs 3-bit signals corresponding to the output signals (Value1, Value2 and Value3) of the first to third decision units XOR1, XOR2 and XOR3, the output signals (Value4, Value5 and Value6) of the fourth to sixth decision units XOR4, XOR5 and XOR6, and the output signals (Value7, Value8 and Value9) of the seventh to ninth decision units XOR7, XOR8 and XOR9.

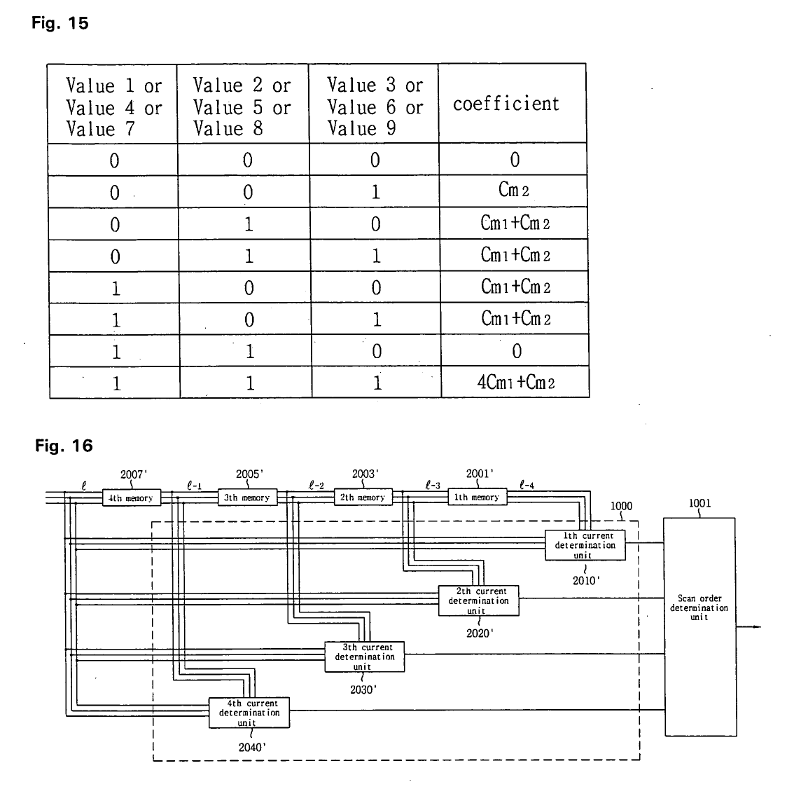

FIG. 15 is a table showing the pattern contents of the image data depending on the output signals of the first to ninth decision units XOR1 to XOR9 included in the circuit block of FIG. 14 according to the present invention.

Referring to FIG. 15, the first to third summation units Int1, Int2 and Int3 sum (C1, C2, C3) the output numbers of the 3-bit signals, which are output from the decoder Dec and correspond to the output signals (Value1, Value2 and Value3) of the first to third decision units XOR1, XOR2 and XOR3, respectively, and then outputs the summation results.

The fourth to sixth summation units Int4, Int5 and Int6 sum (C4, C5 and C6) the output numbers of the 3-bit signals, which are output from the decoder Dec and correspond to the output signals (Value4, Value5 and Value6) of the fourth to sixth decision units XOR4, XOR5 and XOR6, respectively, and then outputs the summation results.

The seventh to ninth summation units Int7, Int8 and Int9 sum (C7, C8 and C9) the output numbers of the 3-bit signals, which are output from the decoder Dec and correspond to the output signals (Value7, Value8 and Value9) of the ninth decision units XOR7, XOR8 and XOR9, respectively, and then outputs the summation results.

The first to third current calculators Cal1, Cal2 and Cal3 receive C1, C2 and C3 from the first, second and third summation units Int1, Int2 and Int3, respectively, and calculate amounts of the displacement current.

The fourth to sixth current calculators Cal4, Cal5 and Cal6 receive C4, C5 and C6 from the fourth, firth and sixth summation units Int4, Int5 and Int6, respectively, and calculate amounts of the displacement current.

The seventh to ninth current calculators Cal7, Cal8 and Cal9 receive C7, C8 and C9 from the seventh to ninth summation units Int7, Int8 and Int9, respectively, and calculate amounts of the displacement current.

The first current summation unit Add1 sums the amounts of the displacement current, which are calculated by the first to third current calculators Cal1, Cal2 and Cal3.

The second current summation unit Add2 sums the amounts of the displacement current, which are calculated by the fourth to sixth current calculators Cal4, Cal5 and Cal6.

The third current summation unit Add3 sums the amounts of the displacement current, which are calculated by the seventh to ninth current calculators Cal7, Cal8 and Cal9.

As described above, the amount of the displacement current with respect to variation in image data corresponding to each cell can be calculated.

FIG. 16 is a block diagram of the data comparator 1000 and the scan order decision unit 1001 of the scan driver in the plasma display apparatus of the present invention taking FIGS. 14 and 15 into consideration.

Referring to FIG. 16, the data comparator 1000 taking FIGS. 14 and 15 into consideration has a structure in which four basic circuit blocks 4 shown in FIG. 16, i.e., first to fourth current decision units 2010′, 2020′, 2030′ and 2040′ are connected. The scan order decision unit 1001 compares the outputs of the four basic circuit blocks and decides a scan order that generates the lowest displacement current.

The first current decision unit 2010′ compares the image data (l, qR) and the image data (l, qG), the image data (l, qG) and the image data (l, qB), the image data (l, qB) and the image data (l, q−4R), the image data (l−4, qR) and the image data (l−4, qG), the image data (l−4, qG) and the image data (l−4, qB), the image data (l−4, qB) and (l−4, q−1R), the image data (l, qR) and the image data (l−4, qR), the image data (l, qG) and (l−4, qG), and the image data (l, qB) and the image data (l−4, qB), respectively.

l and l−4 refer to the l^{th} scan electrode line and the (l−4)^{th} scan electrode line, respectively. qR, qG and qB refer to the R, G and B cells of the q^{th} pixel, respectively. q−1R, q−1G and q−1B refer to the R, G and B cells of the (q−1)^{th} pixel, respectively.

Therefore, the first current decision unit 2010′ compares image data and calculates the amount of the displacement current, which corresponds to the scan order of Type4, as described above.

The second current decision unit 2020′ compares the image data (l, qR) and the image data (l, qG), the image data (l, qG) and the image data (l, qB), the image data (l, qB) and the image data (l, q−1R), the image data (l−3, qR) and the image data (l−3, qG), the image data (l−3, qG) and the image data (l−3, qB), the image data (l−3, qB) and (l−3, q−1R), the image data (l, qR) and the image data (l−3, qR), the image data (l, qG) and (l−3, qG), and the image data (l, qB) and the image data (l−3, qB), respectively. l and (l−3) refer to the l^{th} scan electrode line and the (l−3)^{th} scan electrode line, respectively.

Therefore, the second current decision unit 2020′ compares image data and calculates the amount of the displacement current, which corresponds to the scan order of Type3, as described above.

The third current decision unit 2030′ compares the image data (l, qR) and the image data (l, qG), the image data (l, qG) and the image data (l, qB), the image data (l, qB) and the image data (l, q−1R), the image data (l−2, qR) and the image data (l−2, qG), the image data (l−2, qG) and the image data (l−2, qB), the image data (l−2, qB) and (l−2, q−1R), the image data (l, qR) and the image data (l−2, qR), the image data (l, qG) and the image data (l−2, qG), and the image data (l, qB) and the image data (l−2, qB), respectively. l and (l−2) refer to the l^{th} scan electrode line and the (l−2)^{th} scan electrode line, respectively.

Therefore, the third current decision unit 2030′ compares the image data and calculates the amount of the displacement current, which corresponds to the scan order of Type2, as described above.

The fourth current decision unit 2040′ compares the image data (l, qR) and the image data (l, qG), the image data (l, qG) and the image data (l, qB), the image data (l, qB) and the image data (l, q−1R), the image data (l−1, qR) and the image data (l−1, qG), the image data (l−1, qG) and the image data (l−1, qB), the image data (l−1, qB) and the image data (l−1, q−1R), the image data (l, qR) and the image data (l−1, qR), the image data (l, qG) and (l−1, qG), and the image data (l, qB) and the image data (l−1, qB), respectively. l and (l−1) refer to the l^{th} scan electrode line and the (l−l)^{th} scan electrode line, respectively.

Therefore, the fourth current decision unit 2040′ compares the image data and calculates the amount of the displacement current, which corresponds to the scan order of Type1, as described above.

The scan order decision unit 1001 receives the amounts of the displacement current, which are calculated by the first to fourth current decision units 2010′, 2030′, 2050′ and 2070′, and decides a scan order according to a current decision unit that has output the lowest displacement current.

For example, if the scan order decision unit 1001 determines that the amount of the displacement current, which is received from the second current decision unit 2030′, is the lowest, the scan order decision unit 1001 sets the scan order so that scanning is performed in order of Y1-Y4-Y7-, . . . , Y2-Y5-Y8-, . . . , Y3-Y6-Y9- . . . , in the same manner as the third scan type (Type 3) of FIG. 14.

Furthermore, if the scan order decision unit 1001 determines that the amount of the displacement current, which is received from the third current decision unit 2050′, is the lowest, the scan order decision unit 1001 sets the scan order so that scanning is performed in order of Y1-Y3-Y5-, . . . , Y2-Y4-Y6-, . . . , in the same manner as the second scan type (Type 2) of FIG. 7.

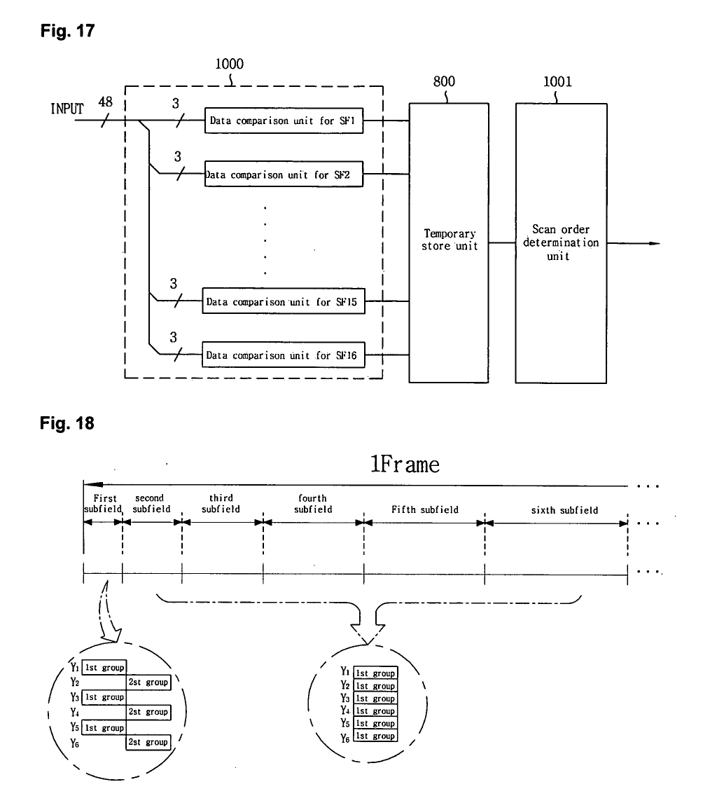

FIG. 17 is a block diagram of an embodiment in which the data comparator and the scan order decision unit according to the present invention are applied to each sub-field.

Referring to FIG. 17, each of a data comparator for a first sub-field (SF1) to a data comparator for a sixteenth sub-field (SF16) calculates the amount of the displacement current according to an image pattern in a corresponding sub-field with respect to a plurality of scan types, and stores the calculated amount in a buffer 800.

Each of the data comparator for the first sub-field (SF1) to the data comparator for the sixteenth sub-field (SF16) is the same as the block construction of the data comparator shown in FIG. 12. Each of the data comparator for the first sub-field (SF1) to the data comparator for the sixteenth sub-field (SF16) calculates the amount of the displacement current according to a pattern of image data in each sub-field with respect to a plurality of scan types, and stores the calculated amount in the buffer 800.

The scan order decision unit 1001 compares the amounts of the displacement current according to the patterns of the image data for the respective sub-fields, which are received from the buffer 800, knows the pattern of the image data having the lowest displacement current, and decides a scan order every sub-field.

In the plasma display apparatus and driving method thereof of the present invention as described above, the displacement current between the scan electrode lines corresponding to a plurality of scan types are calculated, and lines corresponding to the scan types having the lowest displacement current are sequentially scanned.

That is, it has been shown in FIG. 7 that the displacement current between lines in which scan types are spaced apart one another at regular intervals by a predetermined number is calculated, and a scan type having the lowest displacement current is selected. However, the displacement current between lines in which scan types are spaced apart one another irregularly or according to a predetermined rule can be calculated, and a scan type having the lowest displacement current can be selected. Furthermore, it has been described above that the displacement current is calculated using weights (Cm2, Cm1+Cm2, or 4Cm1+Cm2), which include at least one of capacitances (Cm1 and Cm2). However, the amounts of the displacement currents of the sub-fields can be found by summing the values of “u0”v or “u1”v in such a manner that, in the case where weights are not used and the displacement current does not flow, the amount of the displacement current is set to “u0”v and in the case where the displacement current flows, the amount of the displacement current is set to “u1”v. For example, in FIG. 9, the first to third summation units 736-1 to 736-3 can be constructed using one summation unit, and the current calculators 737-1 to 737-3 and the current summation unit 738 may be omitted. In this case, one summation unit can count the output numbers of C1, C2 and C3, and calculates the count values themselves as displacement currents.

Meanwhile, a sub-field in which the scan electrodes Y are scanned using any one of a plurality of scan types can be arbitrarily decided within one frame. This will be described below with reference to FIG. 18.

FIG. 18 is a view illustrating an exemplary method of selecting a sub-field that scans the scan electrodes Y using any one of a plurality of scan types within one frame.

Referring to FIG. 18, the scan electrodes Y are scanned using the first scan type (Type 1) of FIG. 7 only in a first sub-field having the lowest gray level weight, of sub-fields included in one frame, and the scan electrodes Y are scanned according to a general method, i.e., a sequential scanning method in the remaining sub-fields. In more detail, the displacement current for a plurality of scan types is calculated in selected one or more of sub-fields included in one frame, and the scan electrodes Y are then scanned using a scan type in which the displacement current is the lowest in each sub-field.

It is, however, more preferred that the displacement current with respect to the plurality of scan types are calculated in the respective sub-fields included in one frame, and the scan electrodes Y are scanned according to a scan type in which the displacement current is the lowest in each sub-field, as in FIG. 17.

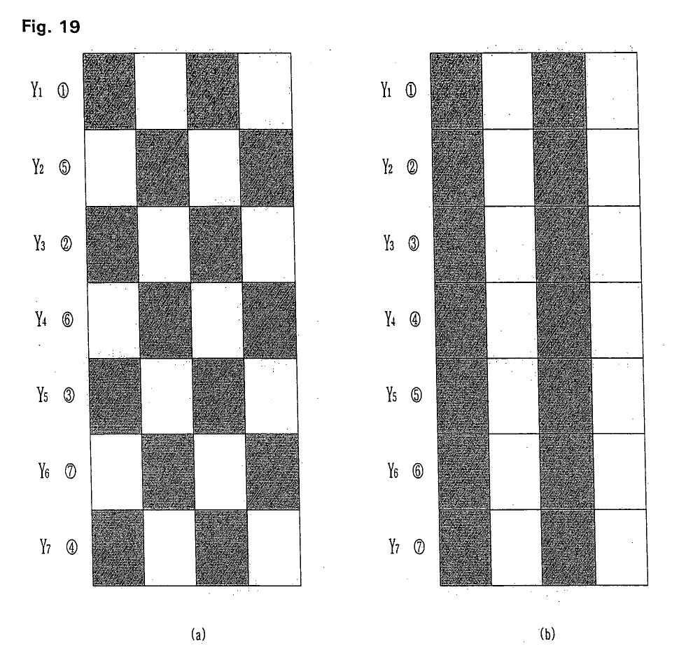

In view of the above description, in the case where patterns of image data include a first pattern and a second pattern, it can be seen that a scanning order in the first pattern of the image data and a scanning order in the second pattern of the image data can be different from each other. This will be described in more detail with reference to FIG. 19.

FIG. 19 is a view illustrating that scan orders may be different in the patterns of two different image data.

Referring to FIG. 19, (a) shows a pattern of image data, in which the logic level “1” and the logic level “0” are alternately disposed in up and down directions and right and left directions. (b) shows a pattern of image data, in which the logic levels “1” and “0” are alternately disposed in right and left directions, but the logic levels “1” and “0” are not changed in up and down directions.

In the case of the image data pattern of (a), the scan order of the scan electrodes Y is Y1-Y3-Y5-Y7-Y2-Y4-Y6. In the case of the image data pattern of (b), the scan order of the scan electrodes Y is Y1-Y2-Y3-Y4-Y5-Y6-Y7. That is, the scan order of the scan electrodes Y is different in the case where the image data have a pattern as shown in (a) and the image data have a pattern as shown in (b).

The reason why the scan order of the scan electrodes Y is adjusted, as described above, has already been described above in detail. Further description thereof will be omitted for simplicity.

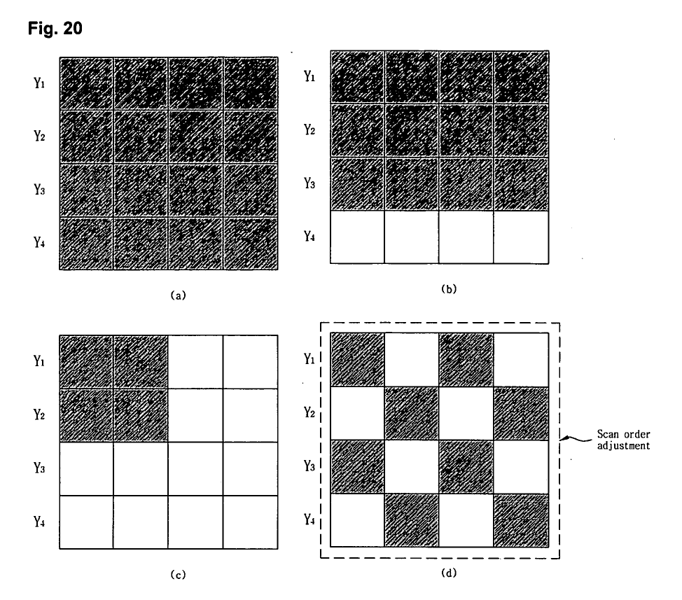

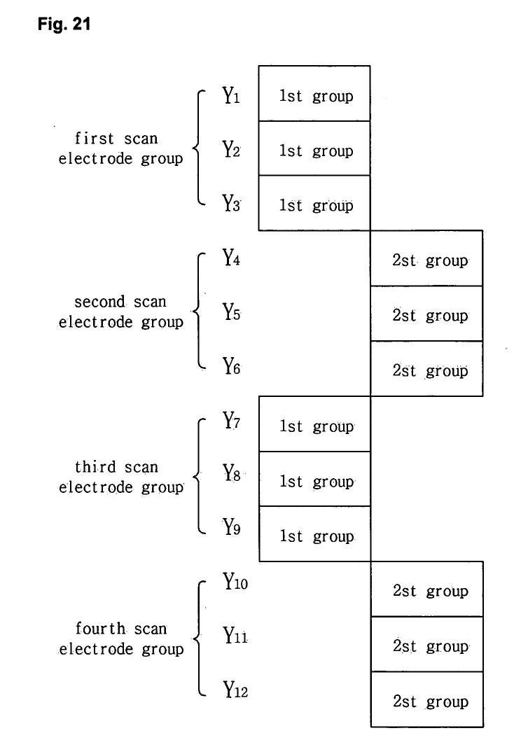

Meanwhile, in the case where the scanning order of the scan electrodes Y is adjusted in consideration of the pattern of the image data as described above, a critical value for the image data pattern can be set and the scanning order can be controlled according to the set critical value. This will be described below with reference to FIG. 20.

FIG. 20 is a view illustrating an example of a method of controlling a scanning order by setting a critical value depending on an image data pattern.

Referring to FIG. 20, (a) shows a case where image data are all high level, i.e., the logic level “1”. (b) shows a case where image data are the logic level “1” on Y1, Y2 and Y3 scan electrode lines, and are the logic level “0” on a Y4 scan electrode line. (c) shows a case where the first and second of Y1 and Y2 scan electrodes are the logic level “1” and the third and fourth of the Y1 and Y2 scan electrodes are the logic level “0”, and image data are all the logic level “1” on the Y3 and Y4 scan electrode lines. (d) shows a case where the logic levels “1” and “0” are alternately disposed.

In this case, in (a), since the data driver IC is not switched, a total of a switching number is 0. In (b), a total of four switching numbers of the data driver IC is generated in up and down directions. In (c), a total of twice switching numbers is generated in up and down directions and a total of twice switching numbers is generated in right and left directions. In (d), a total of twelve switching numbers is generated in up and down directions and a total of twelve switching numbers is generated in right and left directions. It can be seen that the case of (d) has the highest load depending on the pattern.

A load value according to the pattern of the data has been already described in detail. It is preferred that the load value is the sum of a load value in the longitudinal direction of a corresponding data pattern and a load value in the traverse direction of a corresponding data pattern.

Assuming that a previously set critical load value is a load depending on a total of ten switching numbers in up and down directions and a total of ten switching numbers in right and left directions, only the case of the last pattern (d) of the patterns (a), (b), (c) and (d) exceeds the previously set critical load value.

What the meaning that the critical load value is exceeded as described above means that the amount of the displacement current according to a pattern of data exceeds a previously set critical current can be seen through the above description on the present invention.

In this case, in the pattern (d), when the image data are supplied, the scanning order of the scan electrodes Y can be controlled. To control the scanning order of the scan electrodes Y has already been described in detail. Description thereof will be omitted in order to avoid redundancy.

Meanwhile, it has been described above that a scan type having a scan order corresponding to each of the scan electrodes Y is decided and scanning is performed according to the scan order corresponding to each of the scan electrodes Y using the scan type. It is, however, to be understood that a plurality of scan electrodes Y can be set as a scan electrode group and a scan order corresponding to the scan electrode group can be decided. This will now be described with reference to FIG. 21.

FIG. 21 is a view illustrating an example of a method of deciding a scan order corresponding to scan electrode groups, each comprising a plurality of scan electrodes Y.

Referring to FIG. 21, Y1, Y2 and Y3 scan electrodes are set as a first scan electrode group, Y4, Y5 and Y6 scan electrodes are set as a second scan electrode group, Y7, Y8 and Y9 scan electrodes are set as a third scan electrode group, and Y10, Y11 and Y12 scan electrodes are set as a fourth scan electrode group. It has bee shown in FIG. 21 that each scan electrode group is set to include four scan electrodes. It is, however, to be understood that each scan electrode group can be set to include two, three, five, etc. scan electrodes in various manners.

Furthermore, one or more of a plurality of scan electrode groups can be set to include a different number of scan electrodes Y from the remaining scan electrode groups. For example, two scan electrodes Y can be included in a first scan electrode group, and four scan electrodes Y can be included in a second scan electrode group.

In the case where the scan electrode groups are set as described above, if the second type (Type 2) of FIG. 7 is applied, the third scan electrode group is scanned after the first scan electrode group is scanned and the second and fourth scan electrode groups are then sequentially scanned, as in FIG. 21. In other words, the scanning order is Y1, Y2, Y3, Y7, Y8, Y9, Y4, Y5, Y6, Y10, Y11 and Y12.

As an important characteristic of a method of driving a plasma display apparatus of the present invention, what an end point of the scanning of a first scan electrode, of the first scan electrode and a second scan electrode whose scan order is consecutive, of the plurality of scan electrodes Y, is set to be earlier than the starting point of the scanning of the second scan electrode whose scan order is later than the scanning order of the first scan electrode when scanning the scan electrodes Y in the address period will be described below.

FIG. 22 is a view illustrating an example of a driving waveform in the method of driving the plasma display apparatus of the present invention.

Referring to FIG. 22, the method of driving the plasma display apparatus of the present invention includes driving the plasma display apparatus using a driving waveform that is divided into a reset period, an address period and a sustain period, as in FIG. 4. An erase period for erasing some of wall charges, which are excessively formed within discharge cells, may be further included.

In a set-up period of the reset period, a ramp-up waveform (Ramp-up) is applied to the entire scan electrodes Y. The ramp-up waveform generates a weak dark discharge within the discharge cells of the entire screen. The ramp-up discharge also causes positive wall charges to be accumulated on the data electrodes X and the sustain electrodes Z, and negative wall charges to be accumulated on the scan electrodes Y.

In a set-down period of the reset period, after the ramp-up waveform is applied to the scan electrodes Y, a ramp-down waveform (Ramp-down), which falls from a positive voltage lower than a peak voltage of the ramp-up waveform to a predetermined voltage level lower than a ground (GND) level voltage, generates a weak erase discharge within the discharge cells, thus sufficiently erasing wall charges excessively formed on the scan electrodes Y. The set-down discharge causes wall charges of the degree in which a data discharge can be stably generated to uniformly remain within the cells.

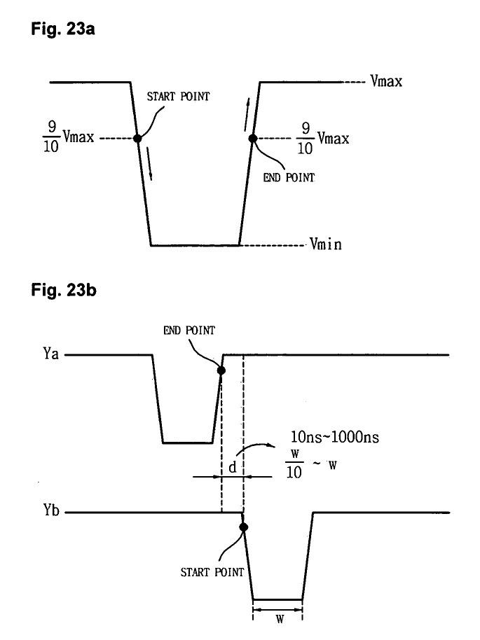

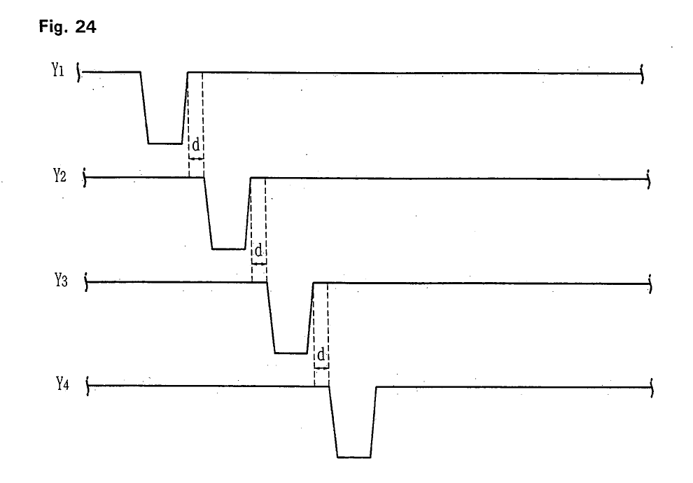

In the address period, the scan electrodes Y are scanned. That is, a negative scan pulse, which falls from a scan reference voltage (Vsc), is applied to the scan electrodes Y. A positive data pulse is also applied to the data electrodes X corresponding to the scan pulse. At this time, when the scan pulse is supplied to the scan electrodes Y, i.e., when the scan electrodes Y are scanned, the end point of the scanning of a scan electrode Ya of the scan electrode Ya and a scan electrode Yb whose scan order is consecutive, of the plurality of scan electrodes Y, i.e., a time point where the supply of the scan pulse to the scan electrode Ya is finished is earlier than the starting point of the scanning of the scan electrode Yb whose scan order is later than that of the scan electrode Ya, i.e., a time point where the scan pulse begins being supplied to the scan electrode Yb by a predetermined time (d). A difference in time between the start point and the end point of scanning will be described in more detail with reference to FIG. 23 later on.

As a voltage difference between the scan pulse and the data pulse and a wall voltage generated in the reset period are added, an address discharge is generated within discharge cells to which the data pulse is applied. Wall charges of the degree in which a discharge can be generated when a sustain voltage (Vs) is applied are formed within discharge cells selected by the address discharge.

In the sustain period, a sustain pulse (sus) is alternately applied to one or more of the scan electrodes Y and the sustain electrodes Z. As a wall voltage within the discharge cells and the sustain pulse are added, a sustain discharge, i.e., a display discharge is generated between the scan electrodes Y and the sustain electrodes Z in the discharge cells selected by the address discharge whenever the sustain pulse is applied.

In addition, after the sustain discharge is completed, in the erase period, a voltage of an erase ramp waveform (Ramp-ers) having a narrow pulse width and a low voltage level is applied to the sustain electrodes Z, thereby erasing wall charges remaining within the discharge cells of the entire screen.

A method of placing a time lag between the end point and the starting point of the scanning between the two scan electrodes in FIG. 22 will now be described in more detail.

That is, what the end point of the scanning of a first scan electrode, of the first scan electrode and a second scan electrode whose scan order is consecutive, of a plurality of scan electrodes, is set to be earlier than the starting point of the scanning of the second scan electrode whose scan order is later than the scanning order of the first scan electrode, when the scan electrodes Y are scanned in the address period, will be described in more detail below.

FIGS. 23a and 23b are views illustrating an example of a method of placing a time lag between the end point and the starting point of the scanning between two scan electrodes in the method of driving the plasma display apparatus according to the present invention.

FIG. 23a shows the concept of the starting point of the scanning and the end point of scanning, of the scan electrodes Y.

That is, the starting point of the scanning of the scan electrodes Y can be a time point where, when the scan electrodes Y are scanned, a voltage of a scan pulse supplied to the scan electrodes Y becomes 90% (9Vmax/10) or less of the highest voltage, while gradually falling from the highest voltage (Vmax) in an arrow direction.

Furthermore, the end point of the scanning of the scan electrodes Y can be a time point where, when the scan electrodes Y are scanned, a voltage of a scan pulse supplied to the scan electrodes Y becomes 90% (9Vmax/10) or more of the highest voltage, while gradually rising from the lowest voltage (Vmin) in an arrow direction.

Furthermore, a time lag between the end point and the starting point of the scanning between the two scan electrodes is shown in FIG. 23b.

That is, assuming that the scan electrodes include two scan electrodes whose scan order is consecutive, i.e., a scan electrode Ya and a scan electrode Yb, and a scan order of the scan electrode Ya is earlier than that of the scan electrode Yb as shown in FIG. 23b, the end point (t1) of scanning of the scan electrode Ya is earlier than the start point (t2) of scanning of the scan electrode Yb by a distance (d).

In other words, the point of time (t1) where a voltage of a scan pulse supplied to the scan electrode Ya becomes 90% or more of the highest voltage while rising is earlier than the point of time (t2) where the voltage of the scan pulse supplied to the scan electrode Yb becomes 90% or less of the highest voltage while falling, by the distance (d).

The reason why the end point (t1) of scanning of the scan electrode Ya and the start point (t2) of scanning of the scan electrode Yb are set to be different from each other between two scan electrodes whose scan order is consecutive, i.e., the scan electrode Ya and the scan electrode Yb, as described above, is to prevent an erroneous discharge from being generated between the scan electrode Ya and the scan electrode Yb in the address period.

This will be described in more detail. If a scan pulse is applied to the scan electrode Yb while an address discharge is generated by the scan pulse supplied to the scan electrode Ya and a data pulse supplied to the data electrodes X corresponding to the scan pulse, an erroneous discharge is generated such as that an address discharge, which is generated on the scan electrode Ya by a voltage of the scan pulse supplied to the scan electrode Yb, becomes strong or weak. Therefore, after the scan electrode Ya is scanned, i.e., after the supply of the scan pulse to the scan electrode Ya is ended, the scan electrode Yb is scanned, i.e., the scan pulse is supplied to the scan electrode Yb, so that generation of the erroneous discharge can be prevented.

By placing a predetermined time lag between scan pulses respectively supplied to two scan electrodes whose scan order is consecutive as described above, an erroneous discharge, which is generated between the adjacent two scan electrodes in an address period, can be prevented.

In this case, the time lag (d) between the end point of the scanning of the scan electrode Ya and the starting point of the scanning of the scan electrode Yb can be set to have a value, which is less than 1/100 to 1 times of W (a pulse width of a predetermined scan pulse). That is, the relation 0.01 W≦d≦W is established.

Furthermore, considering the relation with the width of the scan pulse, the time lag (d) between the end point of the scanning of the scan electrode Ya and the starting point of the scanning of the scan electrode Yb can be set within a range of 10 ns to 1000 ns.

The reason why the lowest critical value of the time lag (d) between the end point of the scanning of the scan electrode Ya and the starting point of the scanning of the scan electrode Yb is set to 10 ns or higher, i.e., the time lag (d) must be ions or higher, as described above, is that if the time lag (d) is less than 10 ns, an erroneous discharge between the scan electrode Ya and the scan electrode Yb in the address period cannot be prevented sufficiently.

Furthermore, the reason why the highest critical value of the time lag (d) between the end point of the scanning of the scan electrode Ya and the starting point of the scanning of the scan electrode Yb is set to 1000 ns or less, i.e., the time lag (d) must be 1000 ns or less, as described above, is that if the time lag (d) is 1000 ns or higher, the length of the address period becomes excessively long and a driving time cannot be sufficiently secured.

It has been described above that scan pulses supplied to two scan electrodes whose scan order is consecutive are compared. The relation between three or more scan electrodes whose scan order is consecutive will be described below.

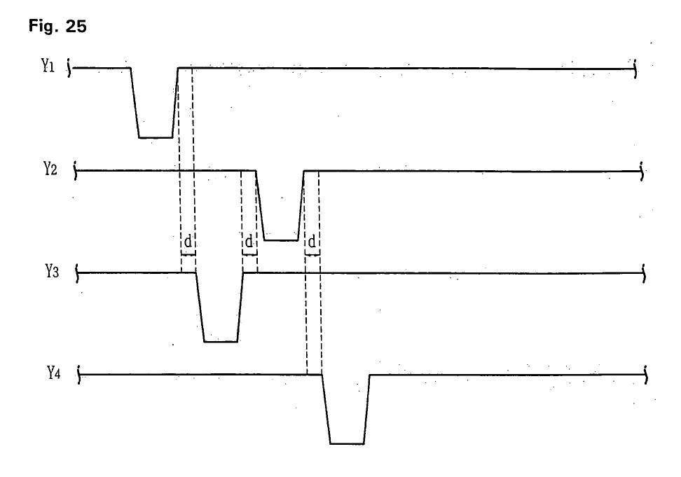

FIG. 24 is a view illustrating the relation between three or more scan electrodes in which scan order is consecutive.

Referring to FIG. 24, assuming that a plurality of scan electrodes comprises four scan electrodes whose scan order is consecutive, i.e., scan electrodes Y1, Y2, Y3 and Y4, the end point of the scanning of the scan electrode Y1, i.e., a time point where the supply of a scan pulse to the scan electrode Y1 is ended is a predetermined time (d) earlier than the starting point of the scanning of the scan electrode Y2 whose scan order is later than that of the scan electrode Y1, i.e., a time point where the supply of the scan pulse to the scan electrode Y2 begins.

Furthermore, the end point of the scanning of the scan electrode Y2 is a predetermined time (d) earlier than the starting point of the scanning of the scan electrode Y3 whose scan order is later than that of the scan electrode Y2. The end point of the scanning of the scan electrode Y3 is a predetermined time (d) earlier than the starting point of the scanning of the scan electrode Y4 whose scan order is later than that of the scan electrode Y3.

In FIG. 24, the scan electrodes Y1, Y2, Y3 and Y4 are adjacent to one another while their scan order is consecutive. That is, there is a time lag (d) between the end point and start point of scanning between the neighboring scan electrodes Y1, Y2, Y3 and Y4 whose scan order is consecutive on the plasma display panel.

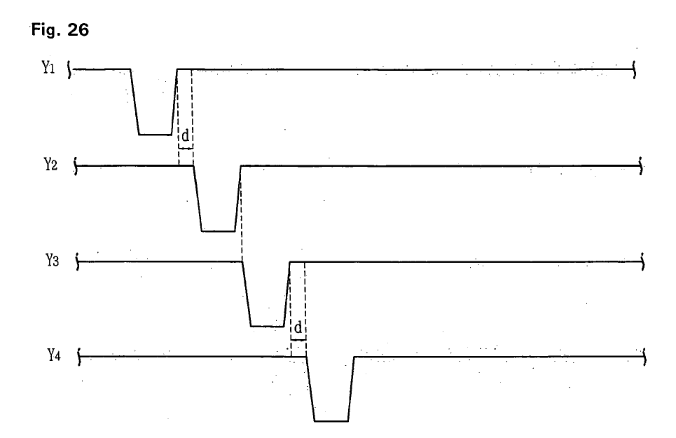

In FIG. 24, only an example in which a time lag between the end point and start point of scanning is applied to the case of the first scan type (Type1) considering the case of FIG. 7 has been shown. It is, however, to be noted that the example can be applied to a variety of scan types. For example, an example in which the method of placing a time lag between the end point and start point of scanning is applied to the second scan type (Type2) will be described below with reference to FIG. 25.

FIG. 25 is a view illustrating an example of a method of placing a time lag between the end point and the starting point of the scanning in the second scan type (Type2) of FIG. 7.

Referring to FIG. 25, assuming that a plurality of scan electrodes comprises four scan electrodes, i.e., scan electrodes Y1, Y2, Y3 and Y4 and the scan order of the four scan electrodes is an order of the scan electrodes Y1-Y3-Y2-Y4, the end point of the scanning of the scan electrode Y1, i.e., a time point where the supply of a scan pulse to the scan electrode Y1 is ended is a predetermined time (d) earlier than the starting point of the scanning of the scan electrode Y3 whose scan order is later than that of the scan electrode Y1, i.e., a time point where the supply of a scan pulse to the scan electrode Y3 begins.

Furthermore, the end point of the scanning of the scan electrode Y3 is a predetermined time (d) earlier than the starting point of the scanning of the scan electrode Y2 whose scan order is later than that of the scan electrode Y3. The end point of the scanning of the scan electrode Y2 is a predetermined time (d) earlier than the starting point of the scanning of the scan electrode Y4 whose scan order is later than that of the scan electrode Y2.

In FIG. 25, the scan electrodes Y1, Y2, Y3 and Y4 are disposed on the plasma display panel so that they are adjacent to one another in order of the scan electrodes Y1-Y2-Y3-Y4. However, the scan order is Y1-Y3-Y2-Y4 in the same manner as the second scan type (Type2) of FIG. 7. That is, although the scan electrodes Y1, Y2, Y3 and Y4 are not adjacent to one another on the plasma display panel, there is the time lag (d) between the end point and the starting point of the scanning between the scan electrodes Y1, Y3, Y2 and Y4 whose scan order is consecutive.

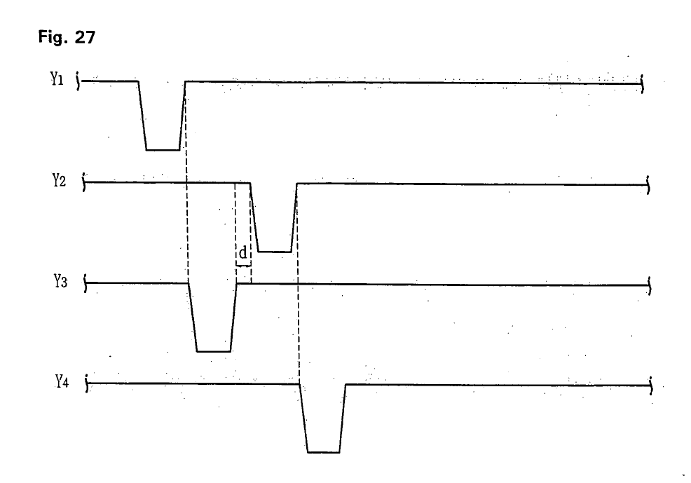

Only a case where there is the time lag (d) between the end point and the starting point of the scanning between the entire scan electrodes has been taken as an example in the above. The time lag (d) can be placed between the end point and the starting point of the scanning between predetermines ones of a plurality of scan electrodes. This will be described with reference to FIG. 26.

FIG. 26 is a view illustrating an example of a case where a time lag is placed between the end point and the starting point of the scanning between predetermined ones of a plurality of scan electrodes.

Referring to FIG. 26, assuming that a plurality of scan electrodes comprises four scan electrodes whose scan order is consecutive, i.e., scan electrodes Y1, Y2, Y3 and Y4, the end point of the scanning of the scan electrode Y1, i.e., a time point where the supply of a scan pulse to the scan electrode Y1 is ended is a predetermined time (d) earlier than the starting point of the scanning of the scan electrode Y2 whose scan order is later than that of the scan electrode Y1, i.e., a time point where the supply of a scan pulse to the scan electrode Y2 begins.

Meanwhile, the end point of the scanning of the scan electrode Y2 is later than or the same as the starting point of the scanning of the scan electrode Y3 whose scan order is later than that of the scan electrode Y2.

Furthermore, the end point of the scanning of the scan electrode Y3 is a predetermined time (d) earlier than the starting point of the scanning of the scan electrode Y4 whose scan order is later than that of the scan electrode Y3.

In FIG. 26, the scan electrodes Y1, Y2, Y3 and Y4 are adjacent to one another while its scan order is consecutive. That is, the end point of the scanning of scan electrodes whose scan order is first is earlier than the starting point of the scanning of scan electrodes whose scan order is late between the scan electrodes Y1, Y2 and between the scan electrodes Y3, Y4, which have a consecutive scan order and are adjacent to each other on the plasma display panel.

FIG. 27 is a view illustrating an example of another case where a time lag is placed between the end point and the starting point of the scanning between predetermined ones of a plurality of scan electrodes.

FIG. 27 shows a method of setting a time lag between the end point of scanning and the starting point of the scanning in the second scan type (Type2) of FIG. 7. For example, assuming that a plurality of scan electrodes comprises four scan electrodes, i.e., scan electrodes Y1, Y2, Y3 and Y4 and the scan order of the four scan electrodes is the order of the scan electrodes Y1-Y3-Y2-Y4, the end point of the scanning of the scan electrode Y1, i.e., a time point where the supply of a scan pulse to the scan electrode Y1 is ended is a predetermined time later than or the same as the starting point of the scanning of the scan electrode Y3 whose scan order is later than that of the scan electrode Y1, i.e., a time point where the supply of a scan pulse to the scan electrode Y3 begins.

In other words, the end point of the scanning of the scan electrode Y1 is not earlier than the starting point of the scanning of the scan electrode Y3 between two scan electrodes, i.e., the scan electrode Y1 and the scan electrode Y3, which have a consecutive scan order, but are disposed with one or more scan electrodes disposed therebetween.

Meanwhile, the end point of the scanning of the scan electrode Y3 is a predetermined time (d) earlier than the starting point of the scanning of the scan electrode Y2, which has a scan order later than that of the scan electrode Y3 and is adjacent to the scan electrode Y3.

Furthermore, the end point of the scanning of the scan electrode Y2 is a predetermined time later than or the same as the starting point of the scanning of the scan electrode Y4 which has a scan order later than that of the scan electrode Y2.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plurality of scan electrodes;
a plurality of data electrodes intersecting the plurality of scan electrodes;
a scan driver which scans the scan electrodes using one of a plurality of scan types whose orders where the plurality of scan electrodes are scanned in an address period are different from one another, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period; and
a data driver that supplies a data pulse to the data electrodes corresponding to the one scan type.

2. The plasma display apparatus as claimed in claim 1, wherein the scan driver calculates a displacement current corresponding to each of the plurality of scan types corresponding to input image data, and scans the scan electrodes according to one scan type whose displacement current is the lowest, of the plurality of scan types.

3. The plasma display apparatus as claimed in claim 2, wherein the scan electrodes comprise the first and second scan electrodes that are separated by a predetermined number of what according to the scan type,
the data electrodes comprise first and second data electrodes,
the plasma display apparatus comprises first and second discharge cells disposed at the intersections of the first scan electrode and the first and second data electrodes, and third and fourth discharge cells disposed at the intersections of the second scan electrode and the first and second data electrodes, and
the scan driver compares data of the first to the fourth discharge cells to calculate a displacement current for the first discharge cell.

4. The plasma display apparatus as claimed in claim 3, wherein the scan driver finds a first result in which the data of the first discharge cell and the data of the second discharge cell are compared, a second result in which the data of the first discharge cell and the data of the third discharge cell are compared and a third result in which the data of the third discharge cell and the data of the fourth discharge cell are compared, decides a calculation equation of the displacement current according to a combination of the first to the third results, and sums the displacement currents calculated using the decided calculation equation to calculate a total of a displacement current for the first discharge cell.

5. The plasma display apparatus as claimed in claim 4, wherein assuming that the capacitance between the adjacent data electrodes is Cm1, and the capacitance between the data electrodes and the scan electrodes and the capacitance between the data electrodes and sustain electrodes is Cm2, the scan driver calculates the displacement current according to a combination of the first to the third results on the basis of Cm1 and Cm2.

6. The plasma display apparatus as claimed in claim 2, wherein the scan driver calculates a displacement current for the plurality of scan types in each of sub-fields of one frame, and scans the scan electrodes according to a scan type in which the displacement current is the lowest for every sub-field.

7. The plasma display apparatus as claimed in claim 2, wherein the scan types comprise a first scan type in which scanning is performed with the scan electrodes being divided into a plurality of groups, and
the scan driver consecutively scans the scan electrodes belonging to the same group in the first scan type in the case where the scan type in which the displacement current is the lowest is a first scan type.

8. The plasma display apparatus as claimed in claim 1, wherein the scan driver calculates a displacement current corresponding to each of the plurality of scan types corresponding to the input image data, and scans the scan electrodes according to at least one of scan types in which the displacement current is less than a predetermined critical displacement current, of the plurality of scan types.

9. The plasma display apparatus as claimed in claim 1, wherein the starting point of the scanning is a time point where a voltage of a scan pulse supplied to the scan electrodes is 90% or less of the highest voltage, while gradually falling from the highest voltage, when the scan electrodes are scanned.

10. The plasma display apparatus as claimed in claim 1, wherein the end point of scanning is a time point where a voltage of a scan pulse supplied to the scan electrodes is 90% or more of the highest voltage, while gradually rising from the lowest voltage, when the scan electrodes are scanned.

11. The plasma display apparatus as claimed in claim 1, wherein the plurality of scan electrodes comprises a third scan electrode whose scan order is consecutive to that of the second scan electrode and is later than that of the second scan electrode, and
the scan driver sets an end point of the scanning of the second scan electrode to be earlier than the starting point of the scanning of the third scan electrodes.

12. The plasma display apparatus as claimed in claim 11, wherein the third scan electrode and the second scan electrode are adjacent to each other, and the second scan electrode and the first scan electrode are adjacent to each other.

13. The plasma display apparatus as claimed in claim 1, wherein the plurality of scan electrodes comprises a third scan electrode whose scan order is consecutive to that of the second scan electrode and is later than that of the second scan electrode, and
the scan driver sets an end point of the scanning of the second scan electrode to be later than the starting point of the scanning of the third scan electrodes.

14. The plasma display apparatus as claimed in claim 13, wherein the third scan electrode and the second scan electrode are adjacent to each other, and one or more scan electrodes different from the first and second scan electrodes are disposed between the second scan electrode and the first scan electrode.

15. The plasma display apparatus as claimed in claim 1, wherein a time lag between the end point of the scanning of the first scan electrode and the starting point of the scanning of the second scan electrode is 10 ns to 1000 ns.

16. The plasma display apparatus as claimed in claim 1, wherein a time lag between the end point of the scanning of the first scan electrode and the starting point of the scanning of the second scan electrode is value ranging from 1/100 to 1 times of a predetermined scan pulse width.

17. A plasma display apparatus comprising:
a plasma display panel in which a plurality of scan electrodes and data electrodes intersecting the scan electrodes are formed;
a scan driver that scans the scan electrodes by setting a scan order of the plurality of scan electrodes to be different from those in the case of a first data pattern in a second data pattern different from the first data pattern of data patterns of input image data, and sets an end point for the scanning of a first scan electrode, of the first scan electrode and a second scan electrode whose scan order is consecutive, of the plurality of scan electrodes, to be earlier than the starting point of the scanning of the second scan electrode whose scan order is later than the scanning order of the first scan electrode, when the scan electrodes are scanned in the address period; and
a data driver that supplies a data pulse to the data electrodes corresponding to the one scan type.

18. The plasma display apparatus as claimed in claim 17, wherein a load value depending on a pattern of data, of any one of the first data pattern and the second data pattern has, is a predetermined critical load value or higher.

19. A method of driving a plasma display apparatus comprising scan electrodes and data electrodes intersecting the scan electrodes are formed, the method comprising the steps of:
scanning the scan electrodes using one of a plurality of scan types whose orders where the plurality of scan electrodes are scanned in an address period are different from one another, wherein an end point of the scanning of a first scan electrode, of the first scan electrode and a second scan electrode whose scan order is consecutive, of the plurality of scan electrodes, is set to be earlier than the starting point of the scanning of the second scan electrode whose scan order is later than the scanning order of the first scan electrode, when the scan electrodes are scanned in the address period; and
supplying a data pulse to the data electrodes corresponding to the one scan type.

20. A method of driving a plasma display apparatus comprising scan electrodes and data electrodes intersecting the scan electrodes are formed, the method comprising the steps of:
scanning the scan electrodes by setting a scan order of the plurality of scan electrodes to be different from those in the case of a first data pattern in a second data pattern different from the first data pattern of data patterns of input image data, wherein an end point of the scanning of a first scan electrode, of the first scan electrode and a second scan electrode whose scan order is consecutive, of the plurality of scan electrodes, is set to be earlier than the starting point of the scanning of the second scan electrode whose scan order is later than the scanning order of the first scan electrode, when the scan electrodes are scanned in the address period; and
supplying a data pulse to the data electrodes corresponding to the one scan type.
